(19) United States
(12) Patent Application Publication
(10) Pub. No.: US 2019/0351672 A1
(43) Pub. Date: Nov. 21, 2019

(54) ROLLER DEVICE AND PRINTER

(71) Applicant: PANASONIC INTELLECTUAL PROPERTY MANAGEMENT CO., LTD., Osaka-shi, Osaka (JP)

(72) Inventors: Etsuo KATOU, Fukuoka (JP); Takafumi SHINGAI, Kumamoto (JP); Eiji OKUZONO, Fukuoka (JP); Tetsuya NISHIO, Fukuoka (JP)

(73) Assignee: Panasonic Intellectual Property Management Co., Ltd., Osaka-shi, Osaka (JP)

(21) Appl. No.: 16/476,072

(22) PCT Filed: Dec. 18, 2017
(86) PCT No.: PCT/JP2017/045240

§ 371 Date: Jul. 3, 2019

(30) Foreign Application Priority Data
Jan. 19, 2017 (JP) 2017-007973
Oct. 25, 2017 (JP) 2017-206682

(51) Int. Cl. B41F 23/04; B41F 31/26

(52) U.S. Cl. CPC B41F 23/0479; B41F 7/02; B41F 31/26

(57) ABSTRACT

A roller device includes a roller, an electronic device, a slip ring, a hood member, and a duct. The electronic device is disposed in an interior of the roller. The slip ring supplies electric power to the electronic device. The hood member covers a region between a rotating shaft of the slip ring and an end portion of the roller. The duct covers the slip ring, and extends in a direction away from the roller.

### TECHNICAL FIELD

The present disclosure relates to a roller device whose temperature can be controlled by using a thermoelectric converter such as a Peltier element, and a printer provided with the same.

### BACKGROUND

Conventionally, various types of rollers such as an ink roller, a plate cylinder, a blanket, and a pressure barrel are used in a planographic offset printer. Among these rollers, a plurality of ink rollers are provided in a passage from an ink storage to the plate cylinder, and are each configured to guide ink from the ink storage to the plate cylinder by rotating in contact with ink. During this operation, the temperature of the ink rollers rises due to heat generated by friction with the ink. Therefore, the temperature of the ink rollers needs to be regulated within a range according to a specification of the ink.

Patent Literature 1 discloses a configuration in which a ventilation device causes air to circulate in an interior of an ink roller to regulate the temperature of the ink roller. More specifically, radiating fins are disposed on an inner peripheral portion of the ink roller, and air is flowed in the interior of the ink roller along a longitudinal direction, so that heat of the radiating fins is removed.

### CITATION LIST

### Patent Literature

PTL 1: Unexamined Japanese Patent Publication No. 5-301336

### SUMMARY

A first aspect of the present disclosure relates to a roller device. The roller device according to the first aspect includes a roller, an electronic device, a slip ring, a hood member, and a duct. The electronic device is disposed in an interior of the roller. The slip ring supplies electric power to the electronic device. The hood member covers a region between a rotating shaft of the slip ring and an end portion of the roller. The duct covers the slip ring, and extends in a direction away from the roller.

According to the roller device of this aspect, a flow channel for cooling air directed from the roller toward the slip ring can be secured, and a flow channel for cooling air exhausted from the slip ring through the duct can be secured. Therefore, the cooling air can be circulated efficiently in the interior of the roller.

A second aspect of the present disclosure relates to a printer. The printer according to the second aspect includes the roller device according to the first aspect and a paper feed device configured to feed a sheet-shaped material to be printed to the roller device. The roller device transfers ink to the sheet-shaped material to be printed.

According to the printer of this aspect, since the roller device according to the first aspect is provided, the temperature of the roller can be efficiently and stably controlled. Therefore, a high-quality printing on the sheet-shaped material to be printed is achieved.

As described above, the present disclosure provides a roller device capable of causing cooling air to circulate efficiently in the interior of a roller, and a printer using the same.

Effects or meanings of the present disclosure will be further clarified in the following description of exemplary embodiments. However, the exemplary embodiments described below are merely examples of practicing the present disclosure, and the present disclosure is not at all limited to the examples described in the following exemplary embodiments.

### BRIEF DESCRIPTION OF DRAWINGS

FIG. 1 is a view schematically illustrating a configuration of a printer according to a first exemplary embodiment.

FIG. 2A is a side view schematically illustrating a configuration near a plate cylinder of a printing unit according to the first exemplary embodiment.

FIG. 2B is a view schematically illustrating a printing method of the printing unit according to the first exemplary embodiment.

FIG. 3A is a view illustrating a configuration of an ink roller according to the first exemplary embodiment.

FIG. 3B is a view showing a state in which the ink roller according to the first exemplary embodiment is mounted on a frame.

FIG. 4A is a view schematically illustrating a roller body as viewed from an exit side of cooling air, according to the first exemplary embodiment.

FIG. 4B is an exploded perspective view schematically illustrating a configuration of a structure to be mounted on the roller body according to the first exemplary embodiment.

FIG. 5 is a side view illustrating a configuration of a roller device according to the first exemplary embodiment.

FIG. 6 is a perspective view illustrating a configuration of an exhaust unit according to the first exemplary embodiment.

FIG. 7 is an exploded perspective view illustrating configurations of a slip ring, a fixing plate, and a coupling member according to the first exemplary embodiment.

FIG. 8A is an exploded perspective view illustrating a configuration of a cylindrical member mounted on the fixing plate according to the first exemplary embodiment.

FIG. 8B is a perspective view showing a state in which the slip ring, the fixing plate, the coupling member, and the cylindrical member are assembled according to the first exemplary embodiment.

FIG. 9 is an exploded perspective view illustrating configurations of a duct, a shaft, a bearing, a nut, and a fixing member according to the first exemplary embodiment.

FIG. 10 is an exploded perspective view illustrating a configuration of a hood member according to the first exemplary embodiment.

FIG. 11 is a perspective view showing a state in which the hood member is assembled according to the first exemplary embodiment.

FIG. 12 is an exploded perspective view illustrating configurations of the ink roller, the hood member, and the fixing member according to the first exemplary embodiment.

FIG. 13 is a cross-sectional view illustrating an end portion on an X-axis positive side of the ink roller and a portion on an X-axis negative side of an exhaust unit, taken by a plane parallel to an X-Z plane and passing through a central axis of the exhaust unit, according to the first exemplary embodiment.

FIG. 14 is a cross-sectional view illustrating a portion on an X-axis positive side of the exhaust unit, the cover, and part of the duct, taken by a plane parallel to an X-Z plane and passing through a central axis of the exhaust unit, according to the first exemplary embodiment.

FIG. 15A is a side view illustrating the exhaust unit in a state before moving the fixing member in a longitudinal direction, according to the first exemplary embodiment.

FIG. 15B is a side view illustrating the exhaust unit in a state after moving the fixing member in the longitudinal direction, according to the first exemplary embodiment.

FIG. 16 is a side view illustrating a configuration of a roller device according to a second exemplary embodiment.

FIG. 17 is a perspective view illustrating a configuration of an exhaust unit according to the second exemplary embodiment.

FIG. 18 is an exploded perspective view illustrating the configuration of the exhaust unit according to the second exemplary embodiment.

FIG. 19 is an exploded perspective view illustrating a configuration of a hood member according to the second exemplary embodiment.

FIG. 20A is a front view illustrating a configuration of a hood body according to the second exemplary embodiment.

FIG. 20B is a side view illustrating the configuration of the hood body according to the second exemplary embodiment.

FIG. 20C is a back view illustrating the configuration of the hood body according to the second exemplary embodiment.

FIG. 21A is a front view illustrating a configuration of a coupling member according to the second exemplary embodiment.

FIG. 21B is a side view illustrating a configuration of the coupling member according to the second exemplary embodiment.

FIG. 21C is a front view illustrating a configuration of a fixing member according to the second exemplary embodiment.

FIG. 21D is a back view illustrating the configuration of the fixing member according to the second exemplary embodiment.

FIG. 22A is a view illustrating the configuration of the fixing member on a front side, according to the second exemplary embodiment.

FIG. 22B is a view illustrating a configuration in which a slip ring is attached to the front side of the fixing member according to the second exemplary embodiment.

FIG. 23A is a view illustrating a configuration in which the slip ring is attached to the front side of the fixing member and three shafts are attached to the fixing member according to the second exemplary embodiment.

FIG. 23B is a view illustrating a configuration in which the slip ring and a duct are attached to the front side of the fixing member and three shafts are attached to the fixing member and the duct according to the second exemplary embodiment.

FIG. 24A is a view showing a state in which a coupling member is mounted on a rotary shaft of the slip ring, as viewed from a back side of the fixing member, according to the second exemplary embodiment.

FIG. 24B is a view showing a state in which a coupling plate is mounted on the coupling member, as viewed from the back side of the fixing member.

FIG. 25A is a view showing a state in which the hood body is mounted on the coupling plate, as viewed from the back side of the fixing member, according to the second exemplary embodiment.

FIG. 25B is a view showing a state in which a flange is mounted on the hood body, as viewed from the back side of the fixing member.

FIG. 26 is a cross-sectional view illustrating the exhaust unit, taken by a plane parallel to a longitudinal direction and passing through a central axis of the exhaust unit, according to the second exemplary embodiment.

FIG. 27A is a side view illustrating the exhaust unit in a state before moving the fixing member in the longitudinal direction, according to the second exemplary embodiment.

FIG. 27B is a side view illustrating the exhaust unit in a state after moving the fixing member in the longitudinal direction, according to the second exemplary embodiment.

### DESCRIPTION OF EMBODIMENTS

Before describing exemplary embodiments of the present disclosure, problems in conventional techniques will be briefly described. An ink roller is supported by frames so as to be rotatable at both end portions of the ink roller. A slip ring configured to supply power to a thermoelectric conversion element is provided at least at one of the end portions of the ink roller. This requires a configuration which allows cooling air to flow into an interior of the roller efficiently without hindering a flow channel of cooling air by the slip ring. However, the above-described Patent literature 1 does not disclose such a configuration at all.

In view of such a problem, the present disclosure provides a roller device capable of causing cooling air to circulate efficiently in the interior of a roller, and a printer using the roller device.

### First Exemplary Embodiment

A first exemplary embodiment of the present disclosure will be described below with reference to the accompanying drawings. For convenience, X, Y and Z-axes perpendicular to one another are added to the respective drawings. In the following, the term “ink” used in connection with an ink roller corresponds to “ink”.

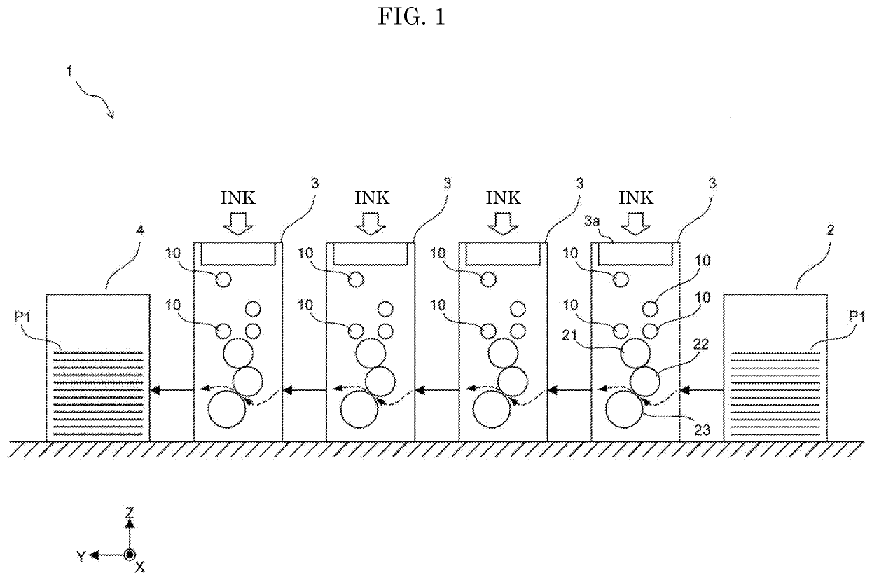

FIG. 1 is a view schematically illustrating a configuration of printer 1. Here, a configuration example of printer 1 configured to perform printing on one side of printing paper P1.

As shown in FIG. 1, printer 1 includes paper feed unit 2, four printing units 3, and accumulating unit 4. Paper feed unit 2 stores printing paper P1 of a predetermined size, which is a material to be printed, and is configured to feed stored printing paper P1 in sequence to printing unit 3 on a most Y-axis negative side. The printing paper P1 fed from paper feed unit 2 is fed in sequence to four printing units 3 by a conveying mechanism in each printing unit 3.

Each of four printing units 3 prints a pattern image of a predetermined color on printing paper P1 fed from paper feed unit 2. For example, four printing units 3 print pattern images of yellow, cyan, magenta, and black, respectively, on printing paper P1.

Each of three printing units 3 on the Y-axis negative side feeds printing paper P1 after having been printed to adjacent printing unit 3 in a Y-axis positive direction by the conveying mechanism. Printing unit 3 on the most Y-axis positive side feeds printing paper P1 after having been printed to accumulating unit 4 by the conveying mechanism. Accumulating unit 4 conveys fed printing paper P1 to an accumulating part in sequence. In this manner, printing paper P1 after having been printed in all the colors is accumulated in accumulating unit 4.

Four printing units 3 have configurations similar to each other. Each of printing units 3 includes ink storage 3a for storing ink of each color. Each of printing units 3 includes four ink rollers 10, plate cylinder 21, blanket 22, and pressure barrel 23. Ink rollers 10, plate cylinder 21, blanket 22, and pressure barrel 23 each have a column shape, and rotate about a rotation axis parallel to an X-axis in a direction parallel to a Y-Z plane.

Four ink rollers 10 guide ink from ink storage 3a to plate cylinder 21 in rotational contact with the ink. In this manner, ink guided by plate cylinder 21 is printed on an outer peripheral surface of plate cylinder 21 in a predetermined drawing pattern. The ink printed the outer peripheral surface of plate cylinder 21 is transferred to blanket 22 at a contact position between plate cylinder 21 and blanket 22. The ink transferred to blanket 22 in this manner is printed on printing paper P1 fed between blanket 22 and pressure barrel 23.

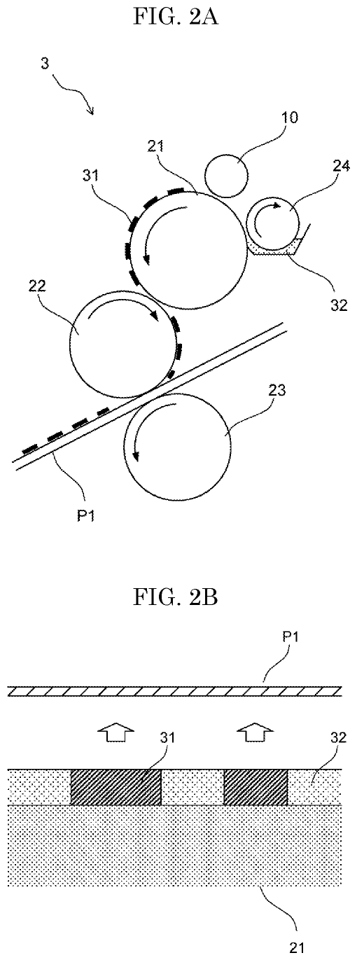

FIG. 2A is a side view schematically illustrating a configuration near plate cylinder 21 of printing unit 3. FIG. 2B is a view schematically illustrating a printing method of printing unit 3.

As shown in FIG. 2A, printing unit 3 further includes water roller 24 at a position in proximity to plate cylinder 21. Water roller 24 is configured to apply water 32 along the outer peripheral surface of the plate cylinder 21. Here, a plate for image formation is mounted in advance on the outer peripheral surface of plate cylinder 21. The plate is configured to cause water to attach to a non-image-forming region. Therefore, the water applied to the outer peripheral surface of plate cylinder 21 by water roller 24 remains only in the non-image-forming region, but not in the image-forming region. Therefore, ink 31 guided to the outer peripheral surface of the plate cylinder 21 from ink roller 10 is adhered only to the image-forming region where no water remains in the outer peripheral surface of plate cylinder 21.

FIG. 2B shows a state in which ink 31 and water 32 are adhered to the outer peripheral surface of plate cylinder 21. In this manner, ink 31 printed on the outer peripheral surface of plate cylinder 21 is transferred to blanket 22 as described above, and then is transferred to printing paper P1. Accordingly, a pattern image according to the plate mounted on the outer peripheral surface of plate cylinder 21 is printed on printing paper P1.

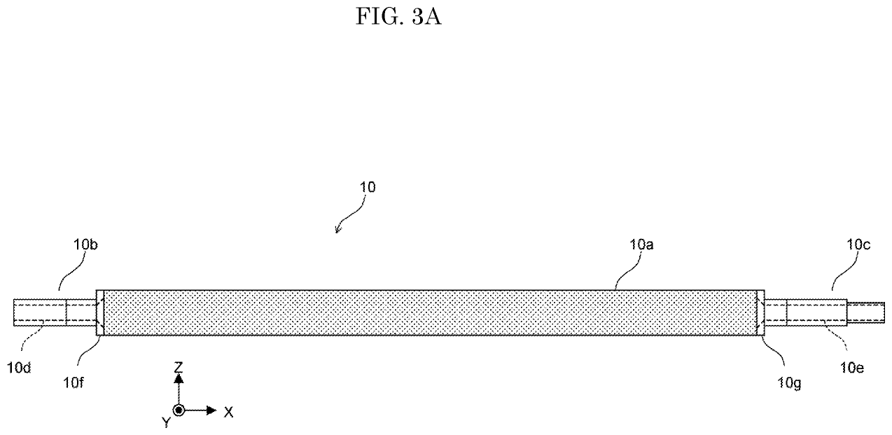

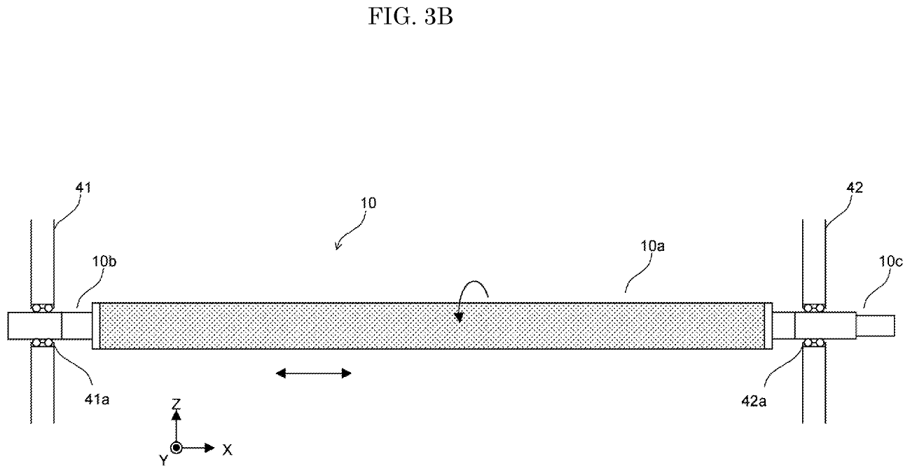

FIG. 3A is a view illustrating a configuration of ink roller 10.

Ink roller 10 includes roller body 10a, and support members 10b and 10c. Roller body 10a is formed of a cylindrical structure body. An outer peripheral surface of roller body 10a comes into contact with ink. Support members 10b and 10c are cylindrical members, and have holes 10d and 10e penetrating through in an X-axis direction. Support members 10b and 10c have shapes symmetry with respect to a central axis parallel to the X-axis. Support members 10b and 10c are made of a metallic material. Support members 10b and 10c are attached on roller body 10a so as to cover both ends of roller body 10a with circular flanges 10f and 10g. It should be noted that screws for attaching flanges 10f and 10g to both ends of roller body 10a is not illustrated in FIG. 3A and FIG. 3B for convenience.

FIG. 3B is a view showing a state in which the ink roller 10 is mounted on frames 41 and 42. For convenience, in FIG. 3B, a junction part between frame 41 and support member 10b and a junction part between frame 42 and support member 10c are illustrated in a state of being seen through in a Y-axis direction.

Ink roller 10 is supported by frames 41 and 42 by fitting support members 10b and 10c into bearings 41a and 42a, respectively. Ink roller 10 is movable in the X-axis direction and is rotatable about an axis parallel to the X-axis. By a drive mechanism (not shown), ink roller 10 is driven in the X-axis direction and is rotated about the axis parallel to the X-axis. In this manner, while ink roller 10 is driven, water (diluted solution) is supplied to the outer peripheral surface of ink roller 10. Then, moisturizing water is mixed with ink which is in contact with the ink roller 10, and ink is adjusted to an adequate emulsified state (viscosity).

It should be noted that such an operation of ink roller 10 generates heat due to friction between ink roller 10 and ink, which rises a temperature of ink roller 10. In contrast, the ink used for printing is mainly UV cured ink, and thus has high viscosity and requires strict temperature control. In particular, when a less expensive ink which requires UV irradiation of high intensity is used, the viscosity of the ink is high, and frictional heat generated between ink roller 10 and the ink is high correspondingly. This requires a configuration to achieve efficient removal of heat generated in ink roller 10 and regulation of the temperature of ink roller 10 to a predetermined temperature with high degree of accuracy.

Accordingly, in the present exemplary embodiment, a thermoelectric converter is disposed on an inner peripheral surface of roller body 10a of ink roller 10 to transfer heat generated on the outer peripheral surface of roller body 10a to the inner peripheral side of roller body 10a. Cooling air is then circulated inside roller body 10a in the X-axis direction via support members 10b and 10c to remove heat transferred by the thermoelectric converter.

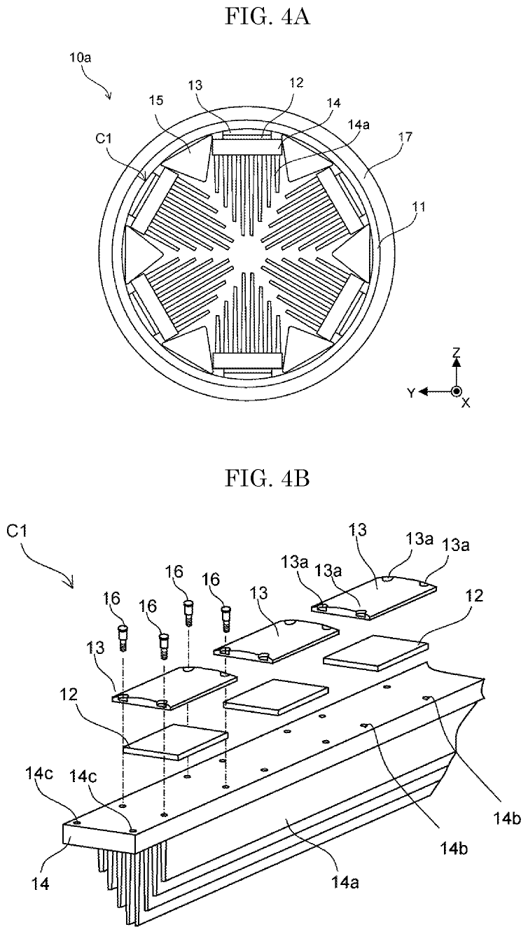

Referring now to FIG. 4A to FIG. 15B, such a temperature regulating structure will be described below.

FIG. 4A is a view schematically illustrating roller body 10a as seen from a cooling air exit side. FIG. 4B is an exploded perspective view schematically illustrating a configuration of one structure C1 to be mounted on roller body 10a.

As shown in FIG. 4A, roller body 10a includes cylindrical bodies 11 and 17 and structures C1. Cylindrical bodies 11 and 17 have respective cylindrical shapes which are the same length as each other, and are made of a metallic material superior in thermal conductivity such as copper or aluminum. An outer diameter of cylindrical body 11 is substantially the same as an inner diameter of cylindrical body 17. When cylindrical body 11 is inserted into an interior of cylindrical body 17, an outer peripheral surface of the cylindrical body 11 comes into contact with an inner peripheral surface of cylindrical body 17.

Six structures C1 are evenly mounted on the inner peripheral surface of cylindrical body 11. In addition, spacers 15 are disposed to fill spaces between one structure C1 and adjacent structures C1. In this configuration, an amount of cooling air directed toward heatsink 14 can be increased.

As shown in FIG. 4B, structure C1 includes thermoelectric converters 12, presser plates 13, and heatsink 14.

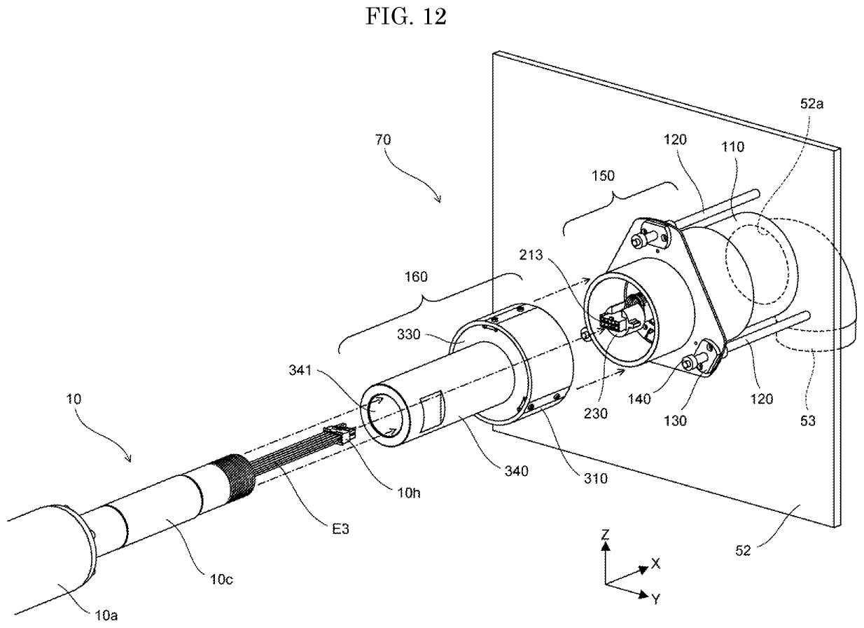

Each of thermoelectric converters 12 is an integration of a number of thermoelectric conversion elements. In other words, in a state in which the number of thermoelectric conversion elements are arranged on one plane, two substrates are mounted so as to come into contact with upper surfaces and lower surfaces of all the thermoelectric conversion elements. On two substrates, electrodes to be joined to the respective thermoelectric conversion elements are arranged. With these electrodes, all the thermoelectric conversion elements are connected in series. Cables E3 (see FIG. 12) for supplying power to the thermoelectric conversion elements are drawn from thermoelectric converters 12.

Heatsink 14 is a heat transfer member configured to transfer heat from a surface (lower surface) of thermoelectric converters 12, which is located at a side opposite to an operating surface (upper surface) of thermoelectric converters 12.

Upper surfaces of presser plates 13 curve in conformity with the inner peripheral surface of cylindrical body 11, and have an arcuate shape. Presser plates 13 are fixed to heatsink 14 with screws 16 with thermoelectric converters 12 interposed between an upper surface of heatsink 14 and lower surfaces of presser plates 13. Presser plates 13 each have holes 13a for allowing insertion of screws 16, and heatsink 14 has screw holes 14b for allowing screws 16 to be screwed in. Screws 16 are screwed into screw holes 14b through holes 13a. In this manner, thermoelectric converters 12 are mounted on the upper surface of heatsink 14.

It should be noted that only three thermoelectric converters 12 are shown in FIG. 4B because a portion near a front end portion of heatsink 14 is shown. Heatsink 14 has a shape extending further rearward. Thermoelectric converters 12 are further mounted on the upper surface of heatsink 14 in the similar configuration as shown in FIG. 4B.

Heatsink 14 and presser plates 13 are made of a material having excellent thermal conduction property such as copper, aluminum, and the like. Presser plates 13 are sheet-shaped members. Heatsink 14 is a plate-shaped member having a predetermined thickness, and has a rectangular shape. The lower surface of heatsink 14 includes a plurality of plate-shaped fins 14a provided in parallel to each other. Fins 14a are made of a material excellent in thermal conductivity. In addition, heatsink 14 includes screw holes 14c penetrating from the top to the bottom at a front end and a rear end.

As shown in FIG. 4A, screws (not shown) are screwed from an outer peripheral surface side of cylindrical body 11 into screw holes 14c in heatsink 14 in a state in which six structures C1 are arranged on an inner peripheral surface of cylindrical body 11. Cylindrical body 11 is also provided with holes (not shown) for screwing screws into screw holes 14c. Screw holes of cylindrical body 11 are adjusted so as to avoid protrusion of head portions of screws from the outer peripheral surface of cylindrical body 11 when heatsink 14 is secured to cylindrical body 11 with the screws.

In this manner, as shown in FIG. 4A, six structures C1 are mounted on the inner peripheral surface of cylindrical body 11 evenly in the circumferential direction. In this state, cylindrical body 11 is fitted to cylindrical body 17. In this manner, roller body 10a is configured as shown in FIG. 4A. It should be noted that illustration of screw holes for securing flanges 10f and 10g of support members 10b and 10c shown in FIG. 3A with screws is omitted in FIG. 4A.

Cooling air flowed into cylindrical body 11 passes through gaps between fins 14a and discharged from cylindrical body 11. Accordingly, heat moving from thermoelectric converters 12 to fins 14a is removed. Accordingly, accumulation of head on heat dissipating surfaces of thermoelectric converters 12 is suppressed, and cooling effect in thermoelectric converters 12 is maintained.

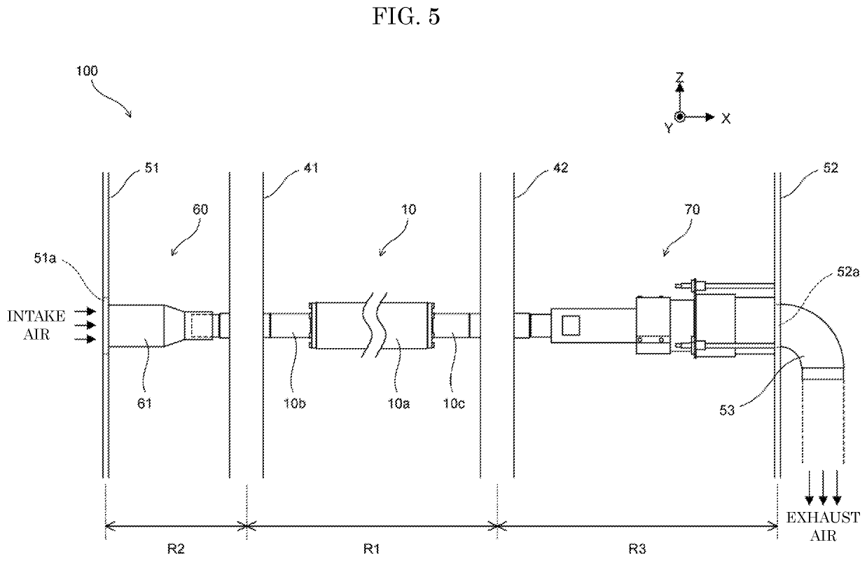

FIG. 5 is a side view illustrating a configuration of roller device 100 according to this exemplary embodiment.

Roller device 100 includes air intake unit 60 and exhaust unit 70 in addition to ink roller 10 having the configuration described above. Air intake unit 60 includes inlet port 51a formed in cover 51 and duct 61 connecting inlet port 51a and support member 10b. An end portion of support member 10b on the X-axis negative side is connected to an end portion of duct 61 on the X-axis positive side so as to fit with substantially no clearance. And the end portion of support member 10b is connected to the end portion of duct 61 so as to be movable in the X-axis direction and rotatable about an axis parallel to the X-axis.

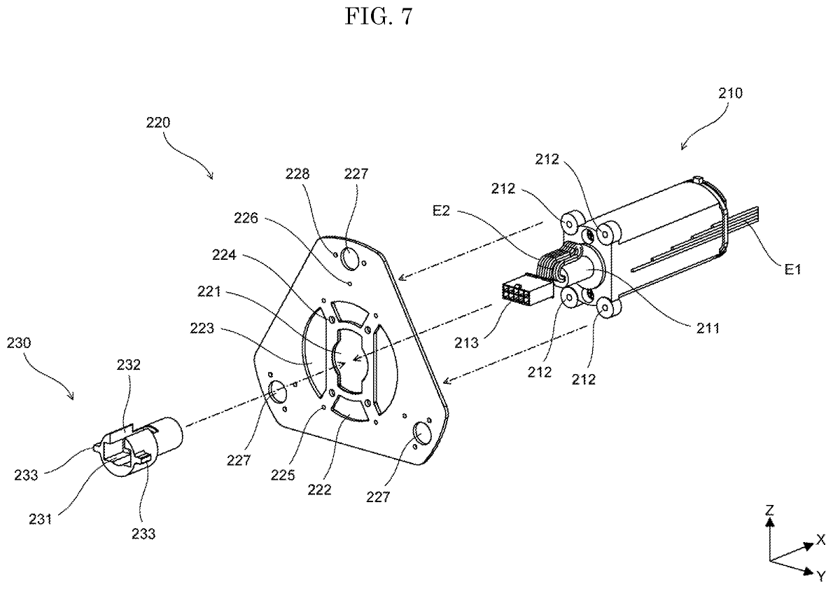

Exhaust unit 70 is disposed to be sandwiched between frame 42 and cover 52. Cables led out from thermoelectric converters 12, which are disposed on the inner peripheral surface of roller body 10a of ink roller 10, are connected to a slip ring mounted in exhaust unit 70. And cables E1 (see FIG. 7) led out from the slip ring pass through an interior of exhaust unit 70, and are led out through exhaust port 52a, which is provided in cover 52, and duct 53, which is connected to exhaust port 52a.

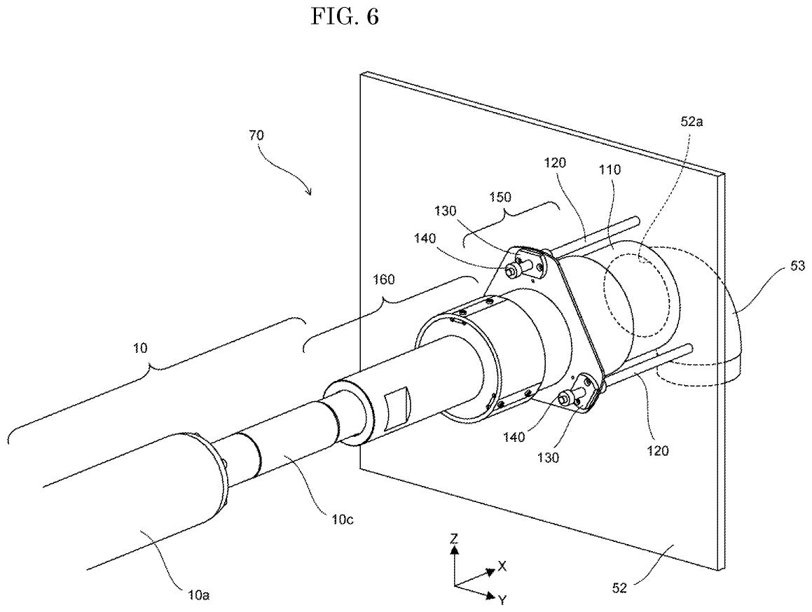

Exhaust unit 70 connects an end of duct 53 and an end portion of support member 10c on the X-axis positive side. And the other end of duct 53 is connected to a blower (not shown) via another duct. With a suction force of the blower, air is taken from inlet port 51a, and then cooling air is taken into duct 61. The cooling air is guided from duct 61 to ink roller 10, and then takes heat from ink roller 10. After that, the cooling air is exhausted through exhaust unit 70, exhaust port 52a and duct 53. A configuration of exhaust unit 70 will be described later with reference to FIG. 6 to FIG. 15B.

In FIG. 5, region R1 is a region for supplying ink from ink storage 3a to plate cylinder 21, and regions R2 and R3 are regions where mechanical parts for driving ink roller 10, plate cylinder 21, blanket 22, pressure barrel 23, and the like are disposed. Therefore, ink is filled in region R1 while oil mist is generated in regions R2 and R3. Frames 41 and 42 and covers 51 and 52 serve as partition walls for partitioning these regions. Therefore, exhaust unit 70 is required to have a configuration for allowing cooling air to circulate without leakage as well as a configuration for suppressing entry of the oil mist into an interior. It should be noted that air intake unit 60 has a configuration in which the end portion of support member 10b fits into duct 61 with no clearance, and thus oil mist does not enter the interior.

Hereinafter, referring to FIG. 6 to FIG. 15B, a configuration of exhaust unit 70 will be described.

FIG. 6 is a perspective view illustrating a configuration of exhaust unit 70.

Exhaust unit 70 includes duct 110, three shafts 120, three bearings 130, three nuts 140, fixing member 150, and hood member 160.

Duct 110 has a cylindrical shape, and is fixed to a surface of cover 52 on the X-axis negative side so as to cover exhaust port 52a of cover 52. Shafts 120 extend in the X-axis direction, and are parallel to each other. End portions of shafts 120 on the X-axis positive side are fixed to a surface of cover 52 on the X-axis negative side. Shafts 120 are inserted into bearings 130, respectively. And each of bearings 130 is supported so as to be slidable in the X-axis direction along each of shafts 120. Nuts 140 are fixed to end portions of shafts 120 on the X-axis negative side, respectively.

Fixing member 150 is supported by shafts 120 so as to be movable in the X-axis direction via bearings 130. Slip ring 210 (see FIG. 7) described later is fixed to fixing member 150. Hood member 160 is supported by slip ring 210 in fixing member 150 so as to be rotatable about an axis parallel to the X-axis. Support member 10c of ink roller 10 is fixed to an end portion of hood member 160 on the X-axis negative side.

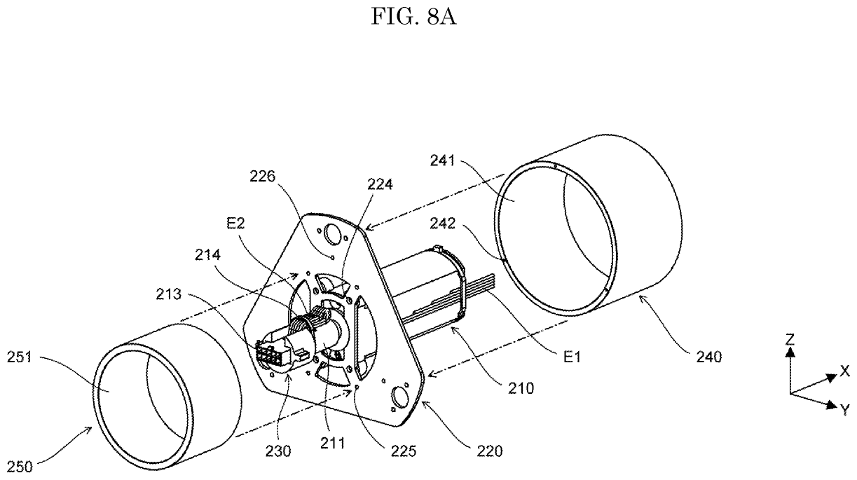

FIG. 7 to FIG. 8B are perspective views for illustrating configurations and assembly of slip ring 210, fixing plate 220, coupling member 230, and cylindrical members 240 and 250.

As shown in FIG. 7, slip ring 210 is configured to supply power, which is supplied from cables E1, to thermoelectric converters 12 in an interior of ink roller 10 via cables E2, which are led out from rotary shaft 211. Cables E1 and E2 are electrically connected in the interior of slip ring 210.

Slip ring 210 includes rotary shaft 211, four screw holes 212, and connector 213. Rotary shaft 211 is provided at a center of a surface of slip ring 210 on the X-axis negative side, and four screw holes 212 are provided at corner portions of the surface of slip ring 210 on the X-axis negative side. Connector 213 is provided at end portions of cables E2 on X-axis negative side and is connected to a connector 10h (see FIG. 12) on ink roller 10 side. Slip ring 210 is fixed by screws to fixing plate 220 from the X-axis positive side via screw holes 212.

Fixing plate 220 is a thin plate member. Fixing plate 220 includes opening 221 for allowing passage of rotary shaft 211 of slip ring 210, cables E2, and connector 213, and includes a pair of ventilation holes 222 and a pair of ventilation holes 223 around opening 221. Fixing plate 220 is also provided with four screw holes 224, four screw holes 225, and three screw holes 226 respectively on circumferences of three circles which have different radii and have a common center at a center of fixing plate 220. Four screw holes 224 are provided at positions corresponding to four screw holes 212 of slip ring 210, four screw holes 225 are provided at positions corresponding to four screw holes (not shown) of cylindrical member 250 (see FIG. 8A), and three screw holes 226 are provided at positions corresponding to three screw holes 242 (see FIG. 8A) of cylindrical member 240.

Furthermore, fixing plate 220 includes three guide holes 227 for allowing passage of three shafts 120 respectively and a pair of screw holes 228 in the vicinity of each of three guide holes 227.

Coupling member 230 includes receiving hole 231 penetrating in the X-axis direction. Rotary shaft 211 of slip ring 210 is fixed to an end portion of receiving hole 231 on the X-axis positive side and connector 213 of slip ring 210 is fixed to an end portion of receiving hole 231 on the X-axis negative side. On an end portion of coupling member 230 on the X-axis negative side, notch 232 is provided on an outer peripheral surface on a Z-axis positive side so as to open an interior of receiving hole 231 to the outside. In addition, on an end portion of coupling member 230 on the X-axis negative side, a pair of flanges 233 are provided on an outer peripheral surface on the Y-axis positive side and the Y-axis negative side so as to project outward, respectively.

As shown in FIG. 7 and FIG. 8A, at the time of assembly, rotary shaft 211 of slip ring 210 is passed through opening 221 of fixing plate 220, and four screw holes 212 of slip ring 210 are secured to four screw holes 224 of fixing plate 220 with screw, not shown. Accordingly, a main body of slip ring 210 is fixed to fixing plate 220, and rotary shaft 211 protrudes from fixing plate 220 to the X-axis negative side.

Subsequently, receiving hole 231 of coupling member 230 is fitted onto rotary shaft 211 of slip ring 210. A screw is inserted into a screw hole, not shown, provided on a surface of coupling member 230 on the Z-axis negative side, and the screw fixes the coupling member 230 to rotary shaft 211. Connector 213 of slip ring 210 is fitted to receiving hole 231 of coupling member 230 in X-axis positive direction. Cables E2 are led from notch 232 to an upper surface of coupling member 230, and are fixed to coupling member 230 by banding band 214.

In this manner as shown in FIG. 8A, slip ring 210, fixing plate 220 and coupling member 230 are integrated. At this time, rotary shaft 211 of slip ring 210 is protruded from fixing plate 220 to the X-axis negative side, and is rotatable about an axis parallel to the X-axis. Therefore, rotary shaft 211 of slip ring 210 rotates in association with rotation of coupling member 230.

As shown in FIG. 8A, cylindrical member 240 includes opening 241 penetrating in X-axis direction, and three screw holes 242 are provided on a surface of cylindrical member 240 on the X-axis negative side. Cylindrical member 250 includes opening 251 penetrating in X-axis direction, and four screw holes (not shown) are provided on a surface of cylindrical member 250 on the X-axis positive side.

As shown in FIG. 8A and FIG. 8B, at the time of assembly, four screw holes of cylindrical member 250 are secured to four screw holes 225 of fixing plate 220 by screws, not shown, and three screw holes 242 of cylindrical member 240 are secured to three screw holes 226 of fixing plate 220 by screws, not shown. Fixing member 150 is formed by integrating fixing plate 220 and cylindrical members 240 and 250. In this manner, assembly of slip ring 210, coupling member 230, and fixing member 150 is completed.

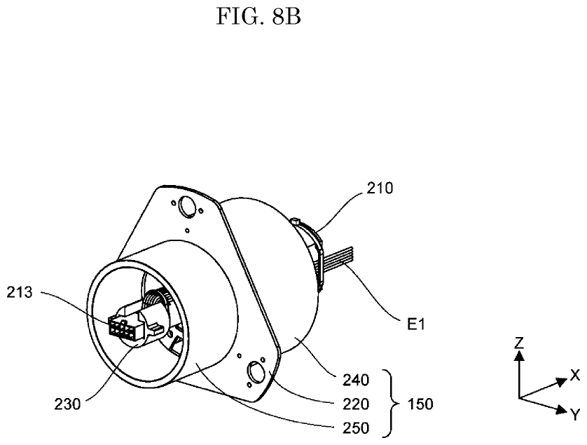

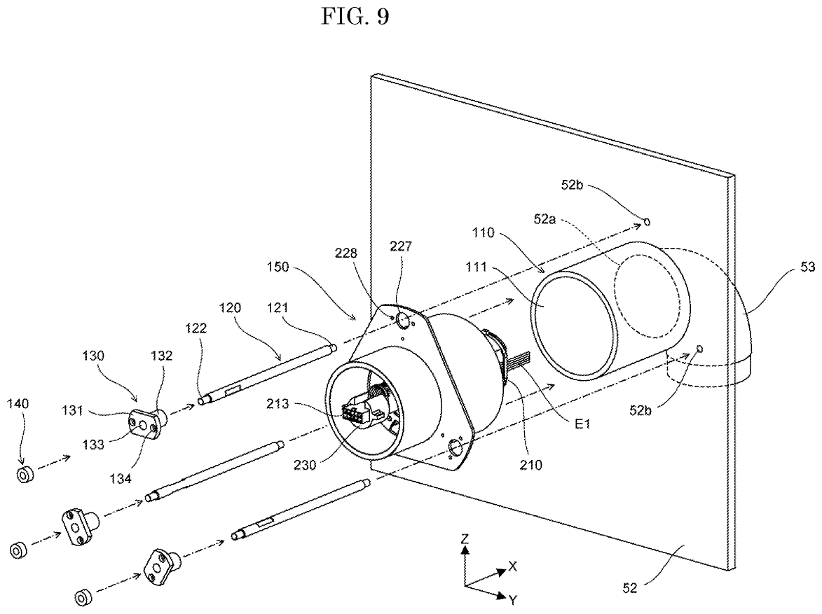

FIG. 9 is a perspective view illustrating configurations and assembly of duct 110, shafts 120, bearings 130, nuts 140, and fixing member 150.

Duct 110 is formed of a cylindrical member, and duct 110 includes opening 111 penetrating in the X-axis direction. Cover 52 includes exhaust port 52a penetrating in the X-axis direction. A diameter of opening 111 is larger than a diameter of exhaust port 52a. It should be noted that duct 53 is connected to exhaust port 52a from the X-axis positive side. Each of shafts 120 has small diameter portion 121 at an end portion on the X-axis positive side and small diameter portion 122 at an end portion on the X-axis negative side. Cover 52 has three holes 52b penetrating in the X-axis direction. Each of bearings 130 includes plate part 131 and projecting portion 132 protruding from plate part 131 in the X-axis positive direction. Each of bearings 130 includes receiving hole 133 at a center so as to penetrate through plate part 131 and projecting portion 132 in the X-axis direction. Plate part 131 has a pair of screw holes 134 which are disposed so as to sandwich receiving hole 133. An outer diameter of nut 140 is larger than an outer diameter of shaft 120.

At the time of assembly, duct 110 is fixed to a surface of cover 52 on the X-axis negative side in such a manner that opening 111 of duct 110 covers exhaust port 52a of cover 52. Three shafts 120 are fixed to cover 52 by press-fitting small diameter portions 121 of three shafts 120 into three holes 52b respectively. Bearings 130 are fixed to fixing member 150 by fitting projecting portions 132 of bearings 130 into guide holes 227 of fixing member 150. And screw holes 134 of bearings 130 and screw holes 228 on fixing member 150 are secured with screws. Receiving holes 133 of three bearings 130 fixed to fixing members 150 are then fitted on three shafts 120, respectively. Accordingly, fixing member 150 is supported by shafts 120 so as to be movable in the X-axis direction. Three nuts 140 are then fitted on small diameter portions 122 of three shafts 120, respectively.

In this manner, as shown in FIG. 12, assembly of duct 110, shafts 120, bearings 130, nuts 140, and fixing member 150 is completed.

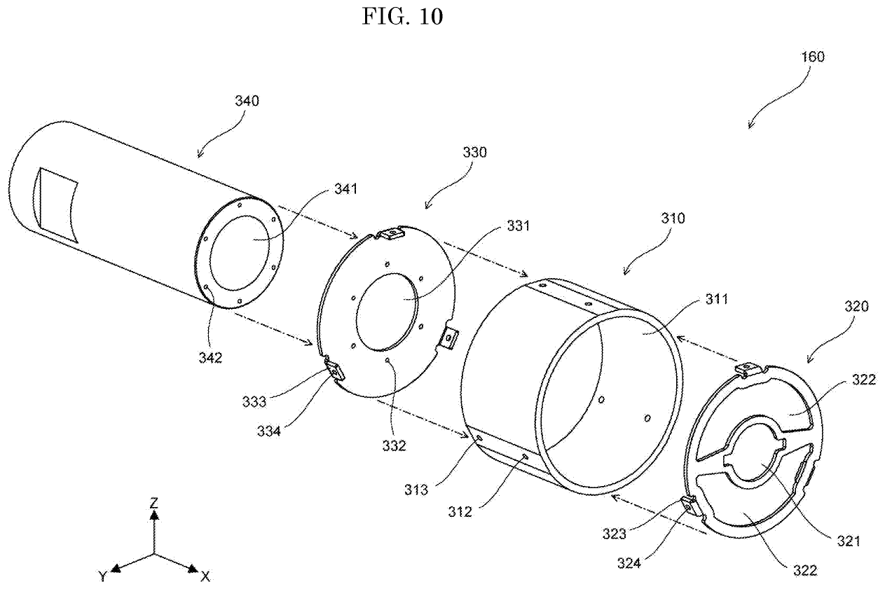

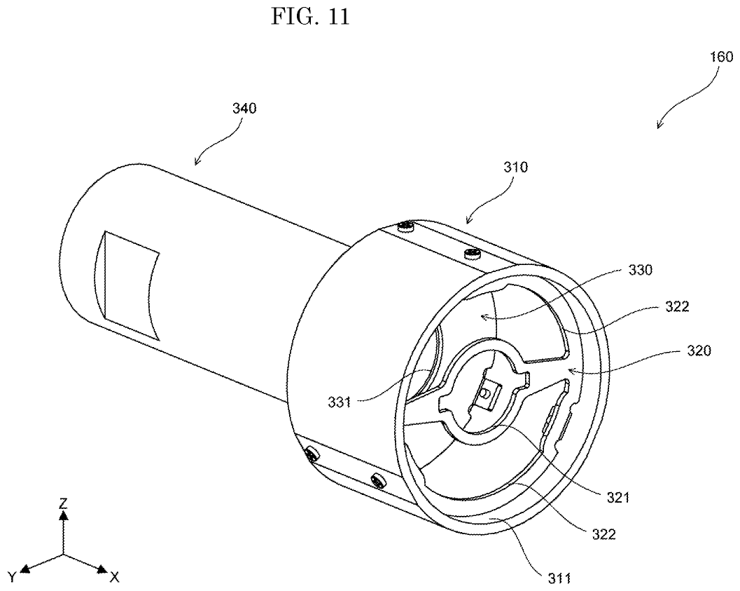

FIGS. 10 and 11 are perspective views illustrating a configuration and assembly of hood member 160.

Hood member 160 includes cylindrical member 310, coupling plate 320, flange 330, and cylindrical member 340.

As shown in FIG. 10, cylindrical member 310 includes opening 311 penetrating in the X-axis direction. On outer peripheral surface of cylindrical member 310, three screw holes 312 and three screw holes 313 are evenly provided, respectively. Each of three screw holes 312 and each of three screw holes 313 is disposed at two different positions in the X-axis direction. Screw holes 312 and 313 penetrate from the outer peripheral surface to opening 311 of cylindrical member 310. Three screw holes 312 are provided in the vicinity of an end portion of cylindrical member 310 on the X-axis positive side, and three screw holes 313 are provided in the vicinity of an end portion of cylindrical member 310 on the X-axis negative side.

Coupling plate 320 is a circular frame member. Coupling plate 320 includes hole portion 321 at a center, and a pair of ventilation holes 322 at positions interposing hole portion 321 therebetween in the Z-axis direction. Hole portion 321 has a shape which allows the end portion of coupling member 230 on the X-axis negative side to be fitted. An outer peripheral surface of coupling plate 320 is also provided with three flanges 323 vertical to the Y-Z plane, and flanges 323 each include screw hole 324. Three screw holes 324 are disposed at positions corresponding to three screw holes 312 of cylindrical member 310. An outer diameter of coupling plate 320 is substantially equal to an inner diameter of opening 311 of cylindrical member 310.

Flange 330 has a disc shape, and includes a circular ventilation hole 331 provided at a center. Six screw holes 332 are provided in the periphery of ventilation hole 331. On outer peripheral surface of flange 330, three flanges 333 vertical to the Y-Z plane are also provided, and flanges 333 each include screw hole 334. Three screw holes 334 are disposed at positions corresponding to three screw holes 313 of cylindrical member 310. An outer shape of flange 330 is substantially equal to an inner diameter of opening 311 of cylindrical member 310.

Cylindrical member 340 is formed of a column-shaped member. Cylindrical member 340 includes hole 341 penetrating in the X-axis direction. An inner diameter of hole 341 is substantially equal to an inner diameter of ventilation hole 331 of flange 330. Six screw holes 342 are provided on the cylindrical member 340 on a surface on the X-axis positive side. Six screw holes 342 are disposed at positions corresponding to six screw holes 332 of flange 330.

At the time of assembly, in a state in which coupling plate 320 is fitted into opening 311 of cylindrical member 310, screw holes 312 and screw holes 324 are secured with screws. Accordingly, coupling plate 320 is fixed to cylindrical member 310. In a state in which a surface of cylindrical member 340 on the X-axis positive side is in contact with a surface of flange 330 on the X-axis negative side, screw hole 342 and screw holes 332 are secured with screws. Accordingly, cylindrical member 340 is fixed to flange 330. In a state in which flange 330 is fitted into opening 311 of cylindrical member 310, screw holes 313 and screw holes 334 are secured with screws. Accordingly, flange 330 is fixed to cylindrical member 310. In this manner, as shown in FIG. 11, assembly of hood member 160 is completed.

FIG. 12 is a perspective view illustrating assembly of hood member 160 and ink roller 10.

Cables E3 of ink roller 10 are connected to thermoelectric converters 12 in roller body 10a. A connector 10h is attached to end portions of the cables E3 on the X-axis positive side. At the time of assembly, cables E3 led out from ink roller 10 are inserted into hole 341, ventilation hole 331, opening 311, and hole portions 321 of hood member 160 (see FIG. 10). The end portion of support member 10c of ink roller 10 on the X-axis positive side is inserted into hole 341, and is fixed to hood member 160. Accordingly, ink roller 10 and hood member 160 are integrated.

Subsequently, connector 10h at distal ends of cables E3 are connected to connector 213 protruded from an interior of fixing member 150 in the X-axis negative direction. Accordingly, cables E2 and cables E3 are electrically connected. An end portion of coupling member 230 on the X-axis negative side is fitted into hole portion 321 (see FIG. 11) of coupling plate 320 of hood member 160. Accordingly, coupling member 230 and hood member 160 are integrated. In this manner, exhaust unit 70 shown in FIG. 6 is constructed.

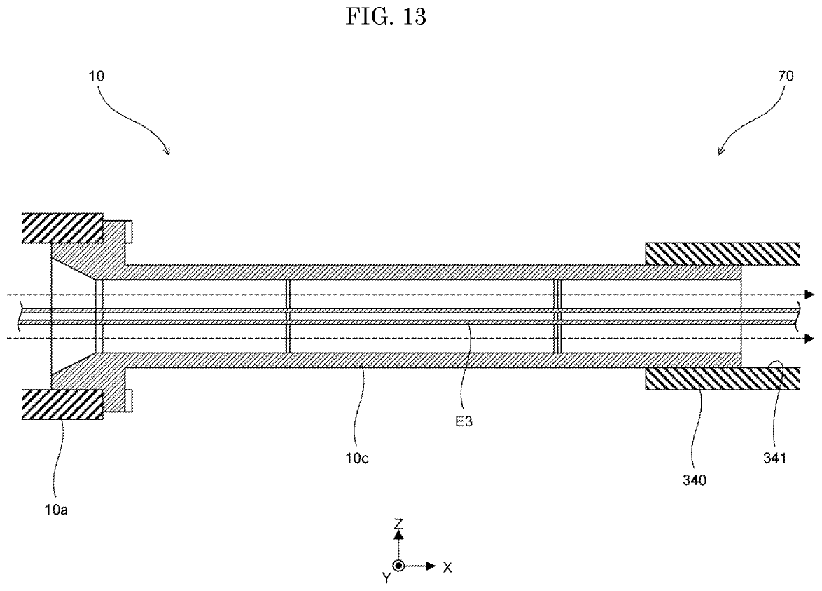

FIG. 13 is a cross-sectional view illustrating an end portion on an X-axis positive side of ink roller 10 and a portion on an X-axis negative side of exhaust unit 70, taken by a plane parallel to an X-Z plane and passing through a central axis of exhaust unit 70. In FIG. 13, a flow of cooling air is indicated by broken line arrows.

As shown in FIG. 13, cooling air flowed from roller body 10a into support member 10c is guided into hole 341 of cylindrical member 340. It should be noted that cables E3 pass from roller body 10a through support member 10c and extend into hole 341 of cylindrical member 340.

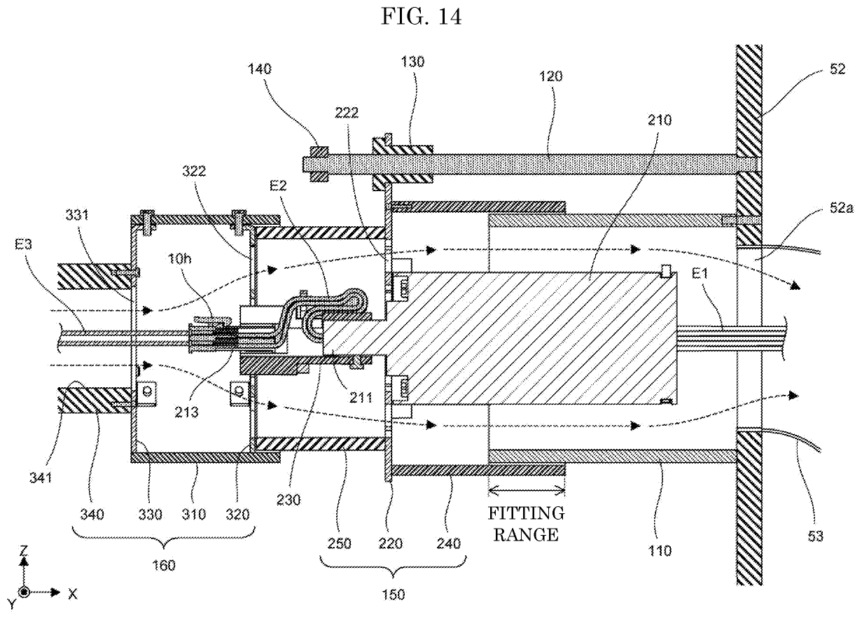

FIG. 14 is a cross-sectional view illustrating a portion on the X-axis positive side of exhaust unit 70, the cover 52, and part of duct 53, taken by a plane parallel to an X-Z plane and passing through a central axis of the exhaust unit 70. In FIG. 14 as well, a flow of cooling air is indicated by broken line arrows.

As shown in FIG. 14, cooling air in cylindrical member 340 passes through ventilation hole 331 of flange 330 and is guided into cylindrical member 310. Cooling air in cylindrical member 310 passes through ventilation hole 322 of coupling plate 320 and is guided into cylindrical member 250. Cooling air in cylindrical member 250 passes through ventilation holes 222 and 223 (see FIG. 7) of fixing plate 220 and is guided to cylindrical member 240 and duct 110. Cooling air in duct 110 passes through exhaust port 52a of cover 52 and is introduced into duct 53.

Here, hood member 160 covers a region between rotary shaft 211 of slip ring 210 and an end portion of support member 10c from outside over the entire circumference. Fixing member 150 is disposed so as to close a region covered by hood member 160 from opposite side from ink roller 10 with respect to hood member 160. Opening 251 of cylindrical member 250 (see FIG. 8A) is fitted into opening 311 (see FIG. 11) of cylindrical member 310 with substantially no clearance. As shown in FIG. 13, the end portion of support member 10c of ink roller 10 is fixed to an end portion of cylindrical member 340 on the X-axis negative side without clearance. Duct 110 is inserted into opening 241 (see FIG. 8A) of cylindrical member 240 with substantially no clearance. In this state, fixing member 150 is movable with respect to duct 110 in the X-axis direction.

In this manner, the flow channel of cooling air in exhaust unit 70 is substantially sealed space. Therefore, air in roller body 10a can be guided efficiently to ducts 110 and 53. Therefore, air can be efficiently circulated in the interior of roller body 10a, and heat can be removed stably and effectively from a heat dissipating surfaces of thermoelectric converters 12. In addition, since the flow channel of exhaust unit 70 is sealed space, oil mist is prevented from entering the interior of exhaust unit 70.

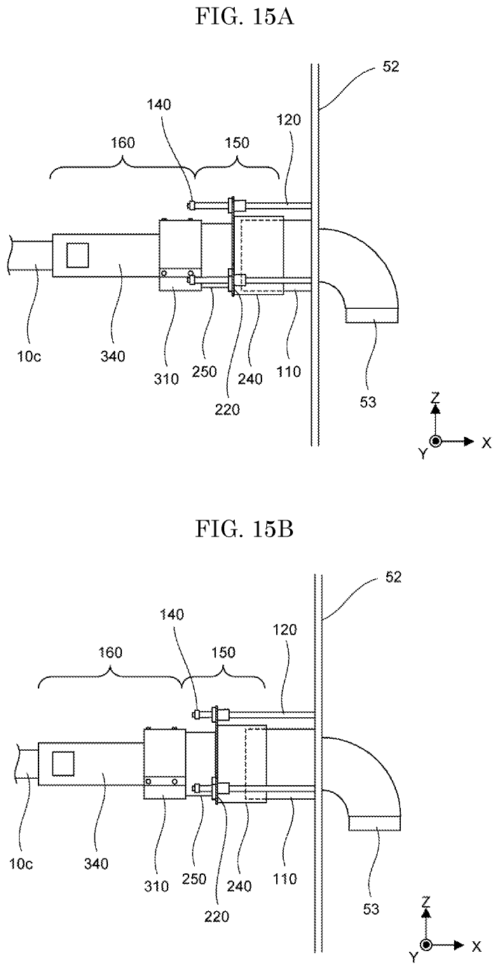

FIGS. 15A and 15B are side views of exhaust unit 70 showing states before and after moving fixing member 150 and hood member 160 in a longitudinal direction.

When ink roller 10 is driven in X-axis positive direction from a state in FIG. 15A, fixing member 150 and hood member 160 move in the X-axis positive direction in association with support member 10c as shown in FIG. 15B. Accordingly, duct 110 is deeply inserted into an interior of fixing member 150 (cylindrical member 240). In this case, duct 110 moves relatively with respect to cylindrical member 240 with an outer peripheral surface in sliding contact with an inner peripheral surface of cylindrical member 240. Therefore, high confidentiality between duct 110 and fixing member 150 is maintained at a high level. Therefore, even when ink roller 10 is driven in the X-axis direction, the flow channel of exhaust unit 70 is maintained as a substantially sealed space.

### <Effects of Exemplary Embodiment>

The present exemplary embodiment exerts the following effects.

Hood member 160 covers a region between rotary shaft 211 of slip ring 210 and ink roller 10. Duct 110 covers slip ring 210 and extends in a direction away from roller 10. Accordingly, a flow channel of cooling air extending from ink roller 10 toward slip ring 210 and a flow channel of cooling air exhausted from slip ring 210 via duct 110 are secured. Therefore, the cooling air can be circulated efficiently in the interior of ink roller 10. In addition, heat is smoothly removed from the heat dissipating surfaces of thermoelectric converters 12, and performance of thermoelectric converters 12 can be maintained at a high level, so that the temperature of ink roller 10 can be controlled efficiently and stably. Therefore, a high-quality printing on the material to be printed is achieved.

Slip ring 210 is supported so as to be movable in a longitudinal direction (X-axis direction) of duct 110, and an insertion amount of slip ring 210 with respect to duct 110 changes in association with movement of slip ring 210 in the longitudinal direction of duct 110. Accordingly, even when slip ring 210 moves in association with the movement of ink roller 10, the flow channel of cooling air can be secured by changing the insertion amount of slip ring 210 with respect to duct 110.

Slip ring 210 is fixed to fixing member 150. Fixing member 150 is disposed to connect a region covered with hood member 160 to duct 110, and includes ventilation holes 222 and 223 provided to communicate between the region covered with hood member 160 and duct 110. Accordingly, airtightness of the flow channel of cooling air near slip ring 210 can be secured by hood member 160, fixing member 150, and duct 110. Therefore, the cooling air can be circulated efficiently in the interior of an ink roller 10.

As shown in FIG. 15A and FIG. 15B, fixing member 150 is supported so as to be movable in the longitudinal direction (X-axis direction) of ink roller 10. In association with the movement of fixing member 150 in the longitudinal direction (X-axis direction), fixing member 150 and duct 110 are fitted so that a fitting range between fixing member 150 and duct 110 (see FIG. 14) changes. Accordingly, even when fixing member 150 moves in association with the movement of ink roller 10, airtightness between fixing member 150 and duct 110 can be maintained at a high level, so that airtightness of the flow channel of cooling air is secured.

As shown in FIG. 15A and FIG. 15B, duct 110 and three shafts 120 are fixed to cover 52. Fixing member 150 is supported by three shafts 120 attached to cover 52 so as to be slidable in the longitudinal direction (X-axis direction). Accordingly, in association with the movement of ink roller 10, fixing member 150 and hood member 160 and slip ring 210 integrated with fixing member 150 can be moved stably in the longitudinal direction (X-axis direction), and thus the movement with respect to duct 110 is achieved. Therefore, the fitting state between duct 110 and fixing member 150 is maintained, and simultaneously, fixing member 150 can be moved stably in the longitudinal direction (X-axis direction).

As shown in FIG. 9, nuts 140 configured to limit a movable range of fixing member 150 are attached on small diameter portions 122 of three shafts 120 on the X-axis negative side. Accordingly, when the fixing member 150 is moved along the shafts 120 as shown in FIG. 15A and FIG. 15B, a movable range of fixing member 150 is limited, and thus contact of fixing member 150 with other components is prevented.

As shown in FIG. 14, hood member 160 is disposed so as to cover fixing member 150 from ink roller 10 side, and fixing member 150 is disposed so as to cover duct 110 from ink roller 10 side. Accordingly, when cooling air flows from ink roller 10 to duct 110, an inflow of air and oil mist from the outside is less likely to occurs at a connecting part between hood member 160 and fixing member 150, and a connecting part between fixing member 150 and duct 110. Hence, cooling air flowed in the interior of ink roller 10 can be guided smoothly into duct 110. Therefore, cooling air can be circulated further smoothly, and heat can be removed efficiently from thermoelectric converters 12 of ink roller 10.

As shown in FIG. 14, cables E3 on thermoelectric converters 12 side and cables E2 on slip ring 210 side are connected inside hood member 160. Accordingly, it is not necessary to provide a through hole for leading cables E3 and cables E2 out in hood member 160. Therefore, cooling air flowing inside hood member 160 is prevented from flowing out from hood member 160. In addition, connectors 213 and 10h for connecting cables E2 and E3, which are located inside hood member 160, are insulated from the influence of moisture outside hood member 160. Therefore, waterproof measures for cables E2 and E3 and connectors 213 and 10h are not necessary. In addition, since parts such as cables E2 and E3 and connectors 213 and 10h are located inside hood member 160, movable range of these parts is limited when these parts are connected and fixed. Therefore, workability for connecting and fixing these parts is improved.

Printer 1 includes roller device 100 configured as described above, and is configured to transfer ink to sheet-like printing paper P1 using roller device 100. As described above, in roller device 100 of the present exemplary embodiment, temperature control of ink roller 10 can be performed efficiently and stably. Therefore, according to printer 1 of the present exemplary embodiment, high quality printing on material to be printed is achieved.

Specifically, ink roller 10 is an ink roller configured to guide ink from ink storage 3a to plate cylinder 21. Therefore, by controlling the temperature of ink roller 10 efficiently and stably depending on the specification of ink, ink having an appropriate viscosity can be supplied stably to plate cylinder 21. Therefore, high quality printing on printing paper P1 is achieved.

As shown in FIG. 14, FIG. 15A, and FIG. 15B, hood member 160 and fixing member 150 are configured to increase in cross-sectional area parallel to the Y-Z plane from an end of support member 10c toward duct 110. Therefore, cooling air flowed in the interior of ink roller 10 can be guided smoothly into duct 110. Therefore, cooling air can be circulated further smoothly, and heat from heat dissipating surfaces of thermoelectric converters 12 can be removed further efficiently. In addition, an increase in cross-sectional area parallel to the Y-Z plane from the end of support member 10c toward duct 110 is relatively gentle. Accordingly, turbulence of cooling air flowing in the interior of ink roller 10 is suppressed, and thus further smooth circulation of cooling air is achieved.

Confidentiality of the flow channel of cooling air near slip ring 210 can be secured by hood member 160, fixing member 150, and duct 110. Accordingly, entry of oil mist generated in region R3 shown in FIG. 5 into exhaust unit 70 can be suppressed. Also, as shown in FIG. 14, duct 110 is fitted inside cylindrical member 240, and cylindrical member 250 is fitted inside cylindrical member 310. Accordingly, air outside exhaust unit 70 is less likely to be drawn into the interior of exhaust unit 70 when cooling air is sucked from duct 53 side, and thus entry of oil mist into exhaust unit 70 is suppressed, and cooling air can be circulated efficiently.

Ink roller 10, hood member 160, fixing member 150, coupling member 230, and slip ring 210 are integrated in the X-axis direction, and such configuration is movable along shafts 120 in the X-axis direction. In addition, ink roller 10, hood member 160, coupling member 230, and rotary shaft 211 of slip ring 210 are rotatable about an axis parallel to the X-axis. Therefore, ink roller 10 can be driven smoothly in the X-axis direction and is rotated smoothly about the axis parallel to the X-axis.

As described above with reference to FIG. 5, in region R3, mechanical parts for driving ink roller 10, plate cylinder 21, blanket 22 and pressure barrel 23 are disposed. According to the present exemplary embodiment, shafts 120 are disposed on the X-axis positive side in region R3, and a capacity of exhaust unit 70 on the X-axis negative side is smaller than a capacity of exhaust unit 70 on the X-axis positive side. Accordingly, a space for disposing the functional sections can be provided on the X-axis negative side in Region R3.

In the first exemplary embodiment described above, the configuration shown in FIG. 6 is provided on the exhaust side of ink roller 10. However, the configuration shown in FIG. 6 may be provided on an air intake side of ink roller 10 or may be provided both on the air intake side and the exhaust side of ink roller 10. In a case where the configuration shown in FIG. 6 is provided both on the air intake side and the exhaust side of ink roller 10, cables led out from thermoelectric converters 12 may be connected separately to slip rings 210 disposed on the air intake side and the exhaust side.

Alternatively, the shape and the configuration of hood member 160 and the shape and the configuration of fixing member 150 may also be modified as needed. In the configuration in the exemplary embodiment described above, duct 110 is inserted into fixing member 150. However, a configuration in which fixing member 150 is inserted into duct 110 is also applicable. However, as described above, the configuration in which duct 110 is inserted into fixing member 150 is more preferable in terms of suppression of oil mist entering from outside and efficient circulation of cooling air.

In addition, according to the first exemplary embodiment, nuts 140 are attached to small diameter portions 122 provided on the end portions of shafts 120 on the X-axis negative side. However, a configuration that a movable range of fixing member 150 limits is not limited thereto. For example, flanges having a diameter larger than the diameter of the main body portions of the shafts 120 may be provided at the end portions of the shafts 120 on the X-axis negative side.

### Second Exemplary Embodiment

A second exemplary embodiment of the present disclosure will be described below with reference to the accompanying drawings. The configuration of printer 1, the configuration of ink roller 10, the configuration of roller body 10a, and configuration of one structures C1 mounted in the roller body 10a shown in FIG. 1 to FIG. 4B are the same as those in the first exemplary embodiment and thus description will be omitted. Like parts as in the first exemplary embodiment will be dented by the same reference numerals for description.

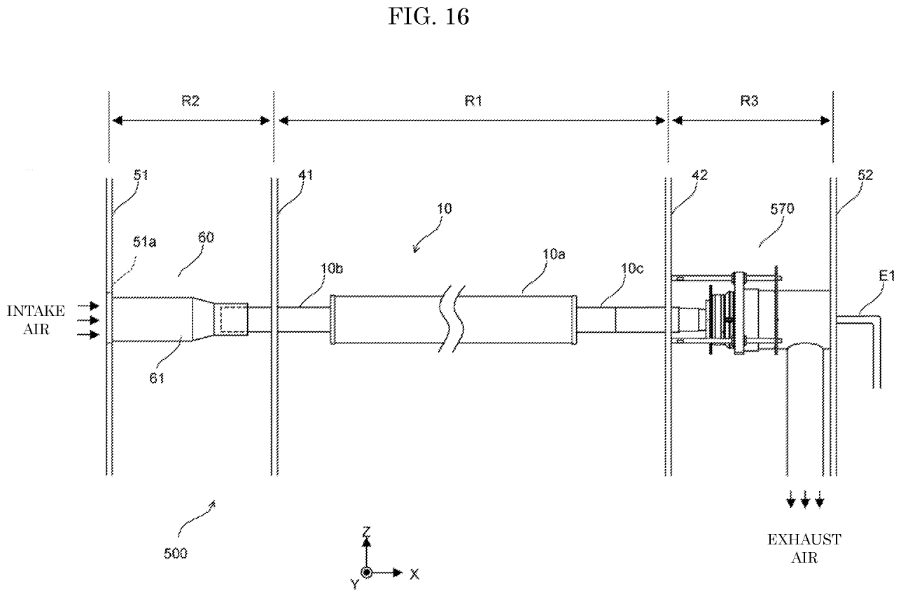

FIG. 16 is a side view illustrating a configuration of roller device 500 according to this exemplary embodiment.

Roller device 500 includes air intake unit 60 and exhaust unit 570 in addition to ink roller 10 provided with the configuration described above. Air intake unit 60 includes inlet port 51a formed in cover 51 and duct 61 connecting inlet port 51a and support member 10b. An end portion of support member 10b on the X-axis negative side is fitted to an end portion of duct 61 on the X-axis positive side with substantially no clearance so as to be movable in the X-axis direction and rotatable about an axis parallel to the X-axis.

Exhaust unit 570 connects the end portion of support member 10c on the X-axis positive side to a blower (not shown). With a suction force of the blower, air is taken from inlet port 51a and cooling air is taken into duct 61. Cooling air flows from duct 61 through ink roller 10 and is exhausted from exhaust unit 570. A configuration of exhaust unit 570 will be described later with reference to FIG. 17 to FIG. 27B.

Exhaust unit 570 is disposed so as to be sandwiched between frame 42 and cover 52. Cables led out from thermoelectric converters 12 disposed on the inner peripheral surface of roller body 10a of ink roller 10 are connected to a slip ring mounted in exhaust unit 570. And cables E1 led out from the slip ring passed through an interior of exhaust unit 570 are led out through a hole of cover 52.

In FIG. 16, region R1 is a region for supplying ink from ink storage 3a to plate cylinder 21, and regions R2 and R3 are regions where mechanical parts for driving ink roller 10, plate cylinder 21, blanket 22, and pressure barrel 23, and the like are disposed. Therefore, ink is filled in region R1, and oil mist is generated in regions R2 and R3. Frames 41 and 42 and covers 51 and 52 serve as partition walls for partitioning these regions. Therefore, exhaust unit 570 is required to have a configuration for allowing cooling air to circulate without leakage as well as a configuration for suppressing entry of the oil mist into an interior. It should be noted that air intake unit 60 has a configuration in which the end portion of support member 10b fits into duct 61 without any clearance, oil mist does not enter the interior.

Hereinafter, referring to FIG. 17 to FIG. 27B, a configuration of exhaust unit 570 will be described. For convenience, unlike the configuration in FIG. 16, illustration of duct portion for guiding cooling air in the Z-axis negative direction is omitted in FIG. 17 to FIG. 27B.

FIG. 17 is a perspective view illustrating a configuration of exhaust unit 570. FIG. 18 is an exploded perspective view illustrating a configuration of exhaust unit 570.

Exhaust unit 570 includes hood member 510, fixing member 520, duct 530, three shafts 540, slip ring 550, and coupling member 560.

Slip ring 550 is configured to supply power, which is supplied from cables E1, to thermoelectric converters 12 in an interior of ink roller 10 via cables, which are led out from rotary shaft 552. Slip ring 550 includes a substantially rectangular flange 551 and rotary shaft 552. Four screw holes 553 are provided at corner portions of flange 551. Slip ring 550 is secured to fixing member 520 with screws via screw holes 553 from the X-axis positive side.

Coupling member 560 is then mounted on rotary shaft 552 of slip ring 550 from the X-axis negative side, and then hood member 510 is mounted on coupling member 560. Accordingly, slip ring 550, fixing member 520 and hood member 510 are integrated. In this state, hood member 510 is rotatable about axis parallel to the X-axis with respect to fixing member 520. Rotary shaft 552 of slip ring 550 rotates in association with rotation of hood member 510.

Fixing member 520 integrated with hood member 510 and slip ring 550 is supported on frame 42 by shafts 540 via bearings 541. At this time, hood member 510 is mounted on an end portion of support member 10c on the X-axis positive side. In addition, duct 530 is fitted to flange 520a of fixing member 520 from the X-axis negative side so as to cover an outside of slip ring 550.

Duct 530 has a configuration in which two cylindrical portions 531 and 532 are mounted on plate 533 from the X-axis positive side and the X-axis negative side, respectively. Plate 533 has a rounded triangular shape. Plate 533 has holes 533a penetrating in the X-axis direction at respective corner portions. Small diameter portions 540a of three shafts 540 on the X-axis positive side are press-fitted into holes 533a. Accordingly, duct 530 is mounted on end portions of shafts 540. In addition, small diameter portions 540b of three shafts 540 on the X-axis negative side are press-fitted into holes 42b of frame 42, respectively. In this manner, exhaust unit 570 shown in FIG. 17 is constructed.

In the state shown in FIG. 17, fixing member 520 is movable along shafts 540 in the X-axis direction. Therefore, when support member 10c moves in the X-axis direction, hood member 510 and slip ring 550 move in the X-axis direction in association with fixing member 520. Likewise, when support member 10c rotates about the axis parallel to the X-axis, rotary shaft 552 of slip ring 550 rotates in association with hood member 510. Duct 530 is fixed to an end portion of shafts 540, and thus does not follow the movement or the rotation of support member 10c.

FIG. 19 is an exploded perspective view illustrating a configuration of hood member 510. For convenience, FIG. 19 shows also coupling member 560.

Hood member 510 includes flange 511, hood body 512, and coupling plate 513. Flange 511 has a disc shape, and has a circular hole 511a provided at a center. The end portion of support member 10c shown in FIG. 17 is press-fitted into hole 511a. Further, flange 511 includes a ring-shaped groove 511b in a surface on the X-axis positive side. And three screw holes 511c penetrating in the X-axis direction are provided in groove 511b.

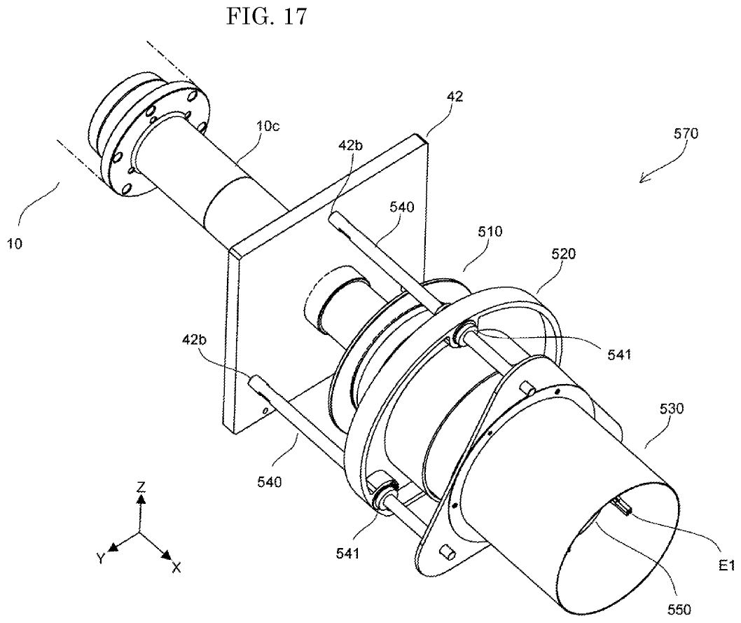

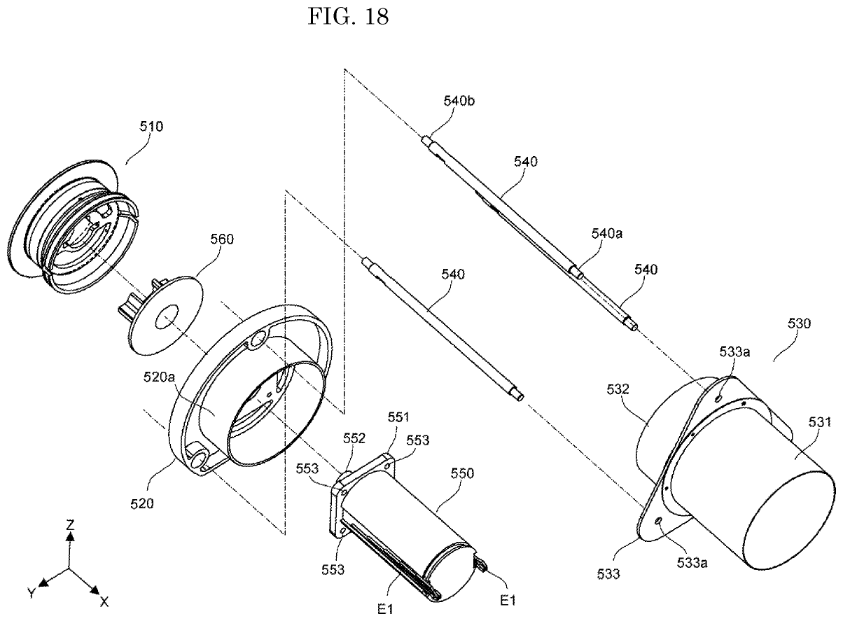

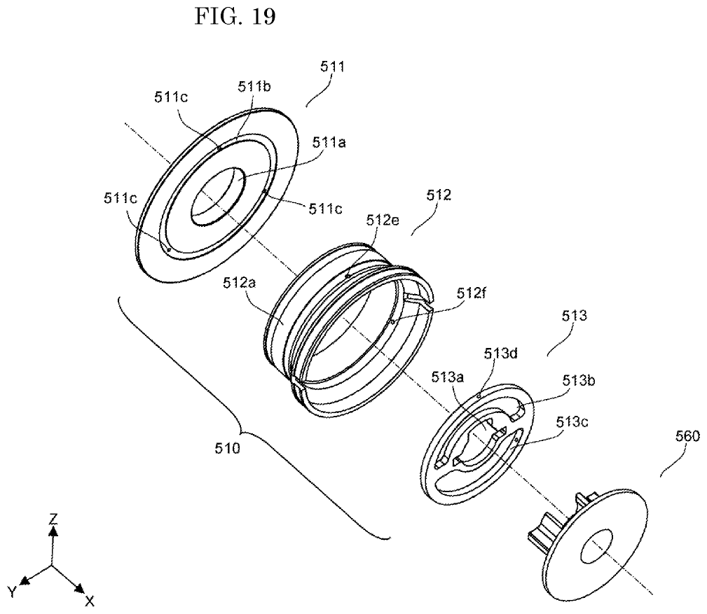

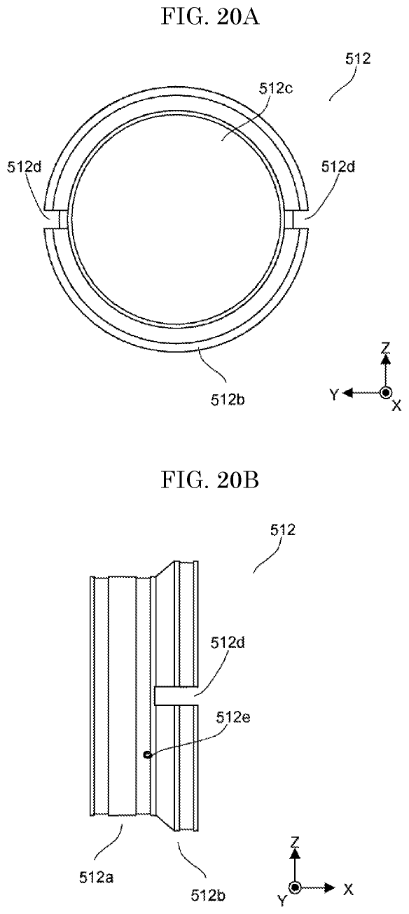

FIG. 20A to FIG. 20C are a front view, a side view, and a back view illustrating a configuration of hood body 512, respectively.

Hood body 512 includes column-shaped body portion 512a and flange portion 512b increasing in radius as it goes in the X-axis positive direction. Inside body portion 512a corresponds to opening 512c penetrating in the X-axis direction. Flange portion 512b has notches 512d at positions symmetrical in the Y-axis direction. Three screw holes 512e penetrating into an inner peripheral surface are provided on an outer peripheral surface of body portion 512a, and three screw holes 512f are provided on an end surface of body portion 512a in the X-axis negative side. Three screw holes 512f are disposed at positions corresponding to three screw holes 511c on flange 511 shown in FIG. 19.

Returning back to FIG. 19, body portion 512a of hood body 512 has the same diameter as groove 511b of flange 511. With body portion 512a fitted into groove 511b, screws are secured in screw holes 512f of body portion 512a via screw holes 511c from X-axis negative side. Accordingly, flange 511 is attached to hood body 512.

Coupling plate 513 is a circular frame member. Coupling plate 513 has hole portion 513a at a center and two ventilation holes 513b and 513c at positions interposing hole portion 513a therebetween in the Z-axis direction. Further, coupling plate 513 includes three screw holes 513d on an outer peripheral surface at positions corresponding to screw holes 512e of hood body 512. An outer diameter of coupling plate 513 is substantially the same as an inner diameter of body portion 512a of hood body 512 at a position where screw holes 512e are provided. Coupling plate 513 is attached to hood body 512 by screws secured to screw holes 512e and screw holes 513d in a state of being fitted into body portion 512a.

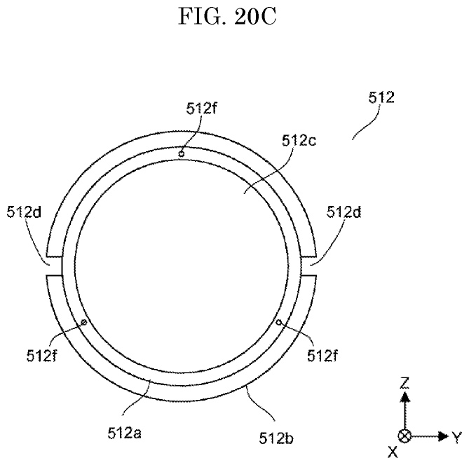

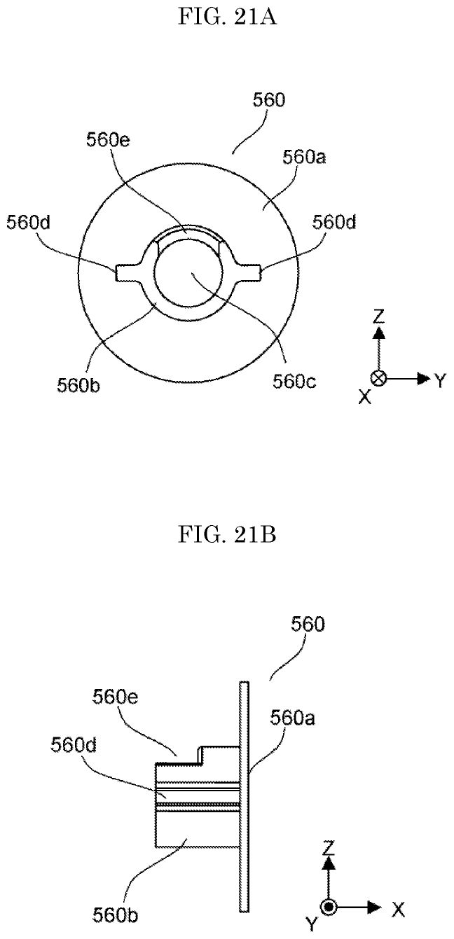

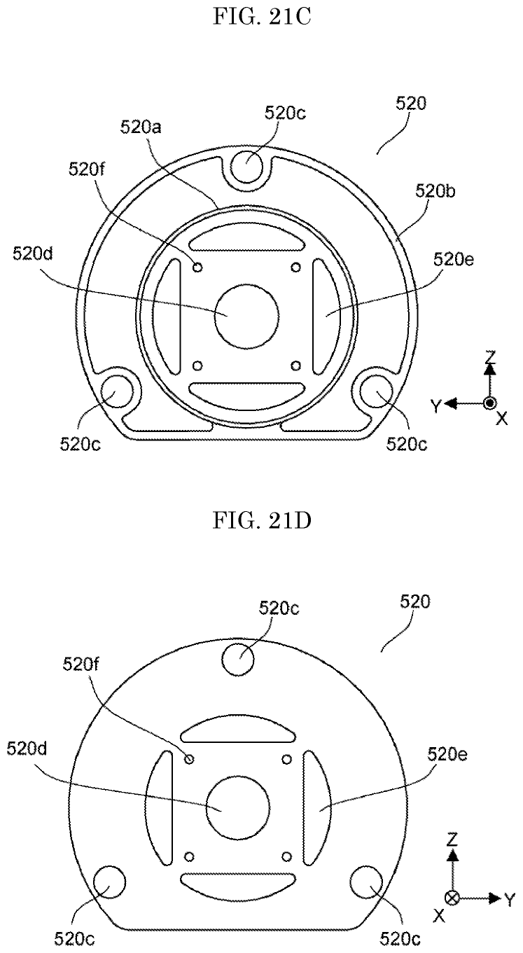

FIG. 21A and FIG. 21B are a front view and a side view, respectively, illustrating a configuration of coupling member 560.

Coupling member 560 has a configuration in which projecting portion 560b projecting in the X-axis negative direction at a center of circular plate part 560a. Coupling member 560 includes receiving hole 560c at a center so as to penetrate through plate part 560a and projecting portion 560b in the X-axis direction of the coupling member 560. Rotary shaft 552 of slip ring 550 shown in FIG. 18 is press-fitted into receiving hole 560c. An outer peripheral surface of the projecting portion 560b includes a pair of flanges 560d projecting in the Y-axis positive and negative directions respectively. In addition, projecting portion 560b includes notch 560e on the Z-axis positive side.

Returning back in FIG. 19, hole portion 513a of coupling plate 513 has a shape which allows projecting portion 560b and flange 560d of coupling member 560 to be fitted. By fitting projecting portion 560b and flange 560d of coupling member 560 into coupling plate 513, coupling member 560 and hood member 510 are integrated.

FIG. 21C and FIG. 21D are a front view and a side view, respectively, illustrating a configuration of fixing member 520.

Fixing member 520 includes two flanges 520a and 520b projecting in the X-axis positive direction. Fixing member 520 includes three guide holes 520c for allowing passage of shafts 540, respectively. Fixing member 520 also include opening 520d for allowing passage of rotary shaft 552 of slip ring 550, and four ventilation holes 520e outside the opening 520d. Fixing member 520 further includes four screw holes 520f outside opening 520d. Four screw holes 520f are provided at positions corresponding to four screw holes 553 of slip ring 550 shown in FIG. 18.

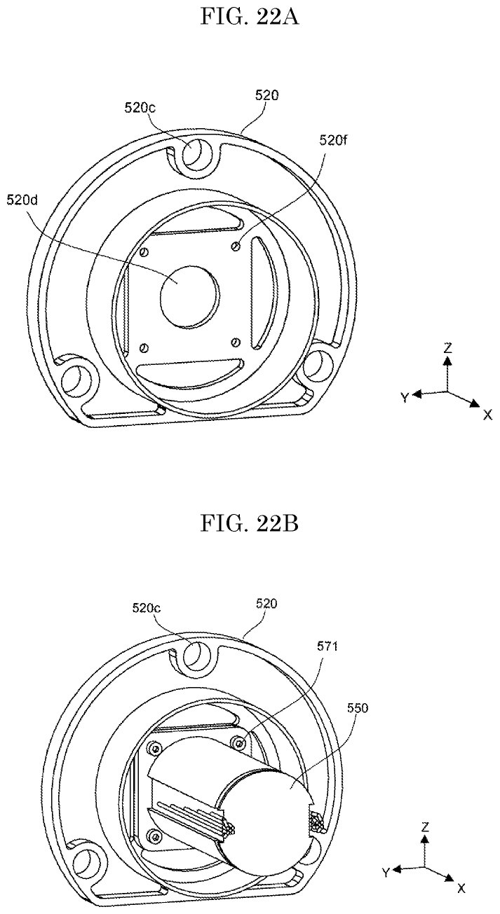

FIG. 22A is a view illustrating a configuration of fixing member 520 on the X-axis positive side. FIG. 22B is a view illustrating a configuration in which slip ring 550 is attached to fixing member 520 on the X-axis positive side.

As shown in FIG. 22A and FIG. 22B, slip ring 550 is secured to screw holes 520f of fixing member 520 with screws 571 with rotary shaft 552 passed through opening 520d of fixing member 520.

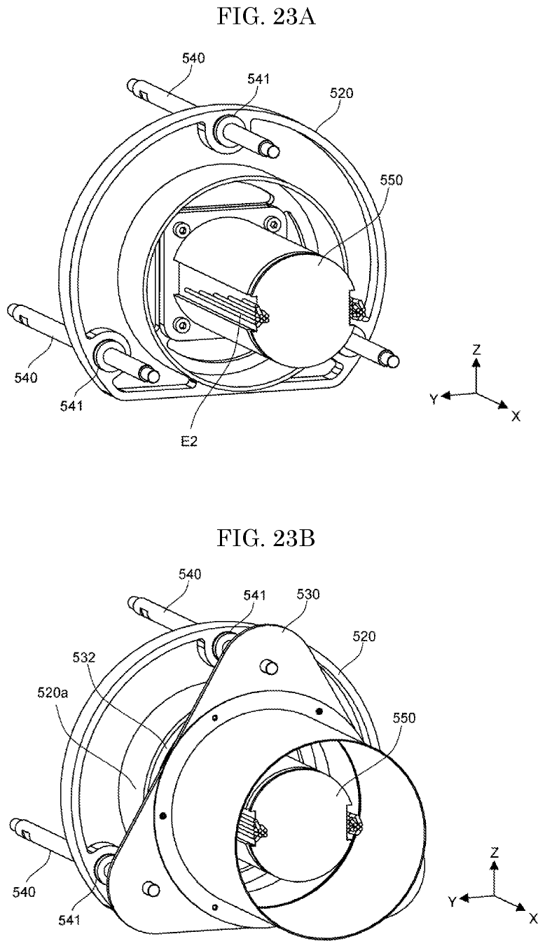

FIG. 23A is a view illustrating a configuration in which three shafts 540 are attached to fixing member 520 from the state shown in FIG. 22B. FIG. 23B is a view illustrating a configuration in which fixing member 520 in a state shown in FIG. 23A is further attached to duct 530.

As shown in FIG. 23A, bearings 541 are fitted into three guide holes 520c (see FIG. 22B) of fixing member 520, respectively, and then shafts 540 are passed through respective bearings 541. In addition, as shown in FIG. 23B, duct 530 is mounted on an end portion of shafts 540. At this time, cylindrical portion 532 of duct 530 is inserted inside flange 520a of fixing member 520 with substantially no clearance. In this state, fixing member 520 is movable with respect to duct 530 in the X-axis direction.

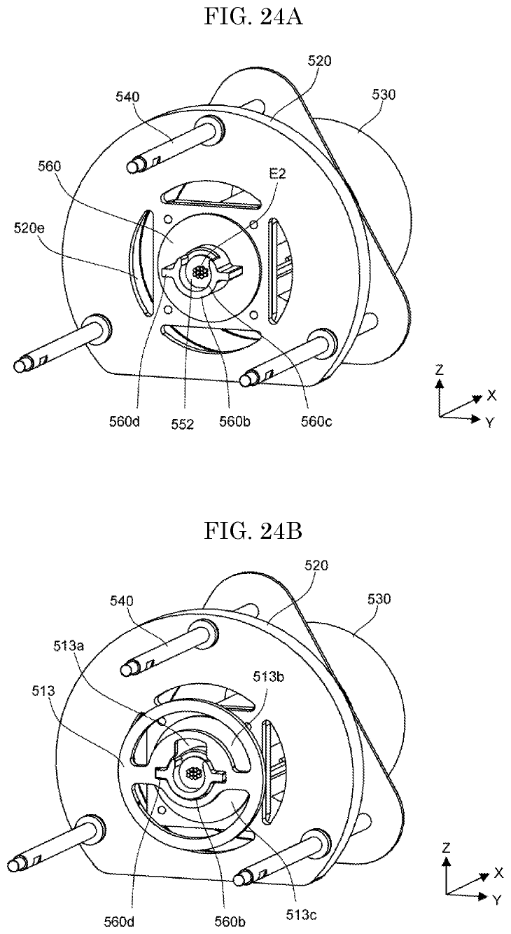

FIG. 24A is a view showing a state in which coupling member 560 is mounted on rotary shaft 552 of slip ring 550, as viewed from X-axis negative side of fixing member 520. FIG. 24B is a view showing a state in which coupling plate 513 is mounted on coupling member 560, as viewed from the X-axis negative side of fixing member 520.

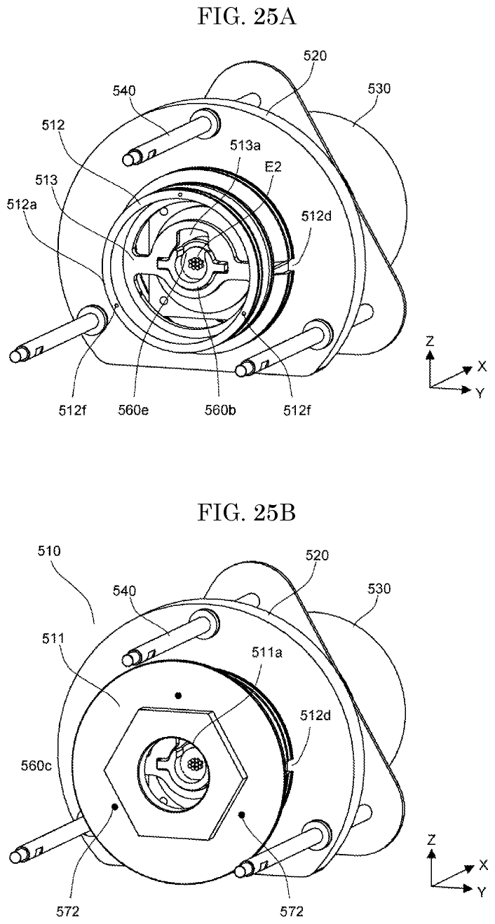

It should be noted that a bundle of cables E2 is shown at a center of rotary shaft 552 in a state of being cut at a base portion in FIG. 24A, but actually, cables E2 extend from rotary shaft 552 to a position joined to cables led out from thermoelectric converters 12. The same applies also to FIG. 24B to FIG. 25B.

As shown in FIG. 24A, coupling member 560 is attached to rotary shaft 552 by fitting rotary shaft 552 into receiving hole 560c of coupling member 560. As shown in FIG. 24B, coupling plate 513 is attached to coupling member 560 by fitting projecting portion 560b and flange 560d into hole portion 513a of coupling plate 513.

FIG. 25A is a view showing a state in which hood body 512 is mounted on coupling plate 513, as viewed from the X-axis negative side of fixing member 520. FIG. 25B is a view showing a state in which flange 511 is mounted on hood body 512, as viewed from the negative side of the X-axis of fixing member 520.

As shown in FIG. 25A, hood body 512 is integrated with coupling plate 513 so as to cover coupling plate 513 from outside. Specifically, as described with reference to FIG. 19, hood body 512 and coupling plate 513 are integrated by securing screws to screw holes 513d via screw holes 512e.

As shown in FIG. 25B, flange 511 is integrated with hood body 512 in a state of being superimposed on a surface of hood body 512 on the X-axis negative side. Specifically, as described with reference to FIG. 19, FIG. 20A to FIG. 20C, hood body 512 and flange 511 are integrated by securing screws 572 to screw holes 512f via screw holes 511c. In this state, support member 10c (see FIG. 17) is fitted into hole 511a of flange 511 from the X-axis negative side. Accordingly, support member 10c and hood member 510 are integrated.

It should be noted that in a state in FIG. 25A, cables E2 pass through hole portion 513a in the X-axis positive direction via notch 560e, and then are led out of hood member 510 through notches 512d on the Y-axis positive side. Likewise, cables (not shown) led out from thermoelectric converters 12 pass from the interior of support member 10c through hole portion 513a, and then are led out of hood member 510 through notches 512d on the Y-axis negative side. In this manner, cables led out from two notches 512d respectively are wound around body portion 512a of hood body 512 in directions opposite from each other and are joined to each other by a connector. Accordingly, thermoelectric converters 12 mounted in the interior of ink roller 10 are connected to slip ring 550, and thus power supply to thermoelectric converters 12 is enabled.

In this manner, by connecting cables E2 on slip ring 550 side and cables on thermoelectric converters 12 side on the outer periphery of hood member 510, hindering of flow of cooling air by cables is suppressed. Accordingly, cooling air can be circulated smoothly, and thus cooling efficiency of thermoelectric converters 12 can be enhanced.

It should be noted that the size of notches 512d is adjusted to a size that can be filled with cables to be led out through notches 512d with substantially no clearance. Accordingly, a space in the interior of hood member 510 may become a substantially sealed space.

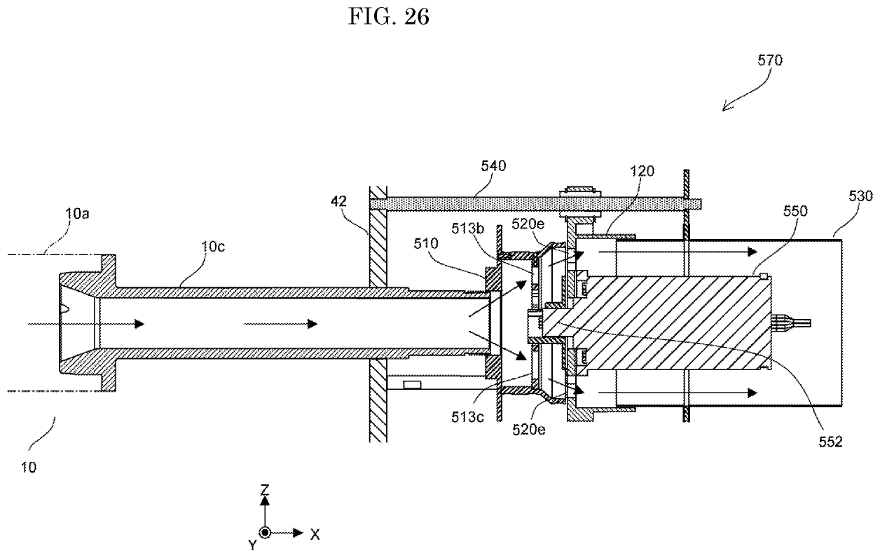

FIG. 26 is a cross-sectional view illustrating exhaust unit 570 taken by a plane parallel to an X-Z plane and passing through a central axis of exhaust unit 570. In FIG. 26, a flow of cooling air is indicated by arrows.

As shown in FIG. 26, cooling air flowed from roller body 10a into support member 10c passes through ventilation holes 513b and 513c (see FIG. 19) of hood member 510 and then is guided to duct 530 through ventilation hole 520e of fixing member 520.

Here, hood member 510 covers a region between rotary shaft 552 of slip ring 550 and an end portion of support member 10c from outside over the entire circumference. Fixing member 520 is disposed so as to close a region covered by hood member 510 from opposite side from ink roller 10 with respect to hood member 510. A surface of fixing member 520 on the X-axis negative side and an end surface of hood member 510 on X-axis positive side are in proximity to each other to a degree of substantially in contact. Duct 530 is fitted inside fixing member 520 with substantially no clearance. Therefore, a flow channel of cooling air in exhaust unit 570 is a substantially sealed space.

Since the flow channel of exhaust unit 570 is a sealed space in this manner, air in roller body 10a can be guided efficiently into duct 530. Therefore, air can be efficiently circulated in the interior of roller body 10a, and heat can be removed stably and effectively from a heat dissipating surfaces of thermoelectric converters 12. In addition, since the flow channel of exhaust unit 570 is sealed space, oil mist is prevented from entering the interior of exhaust unit 570.

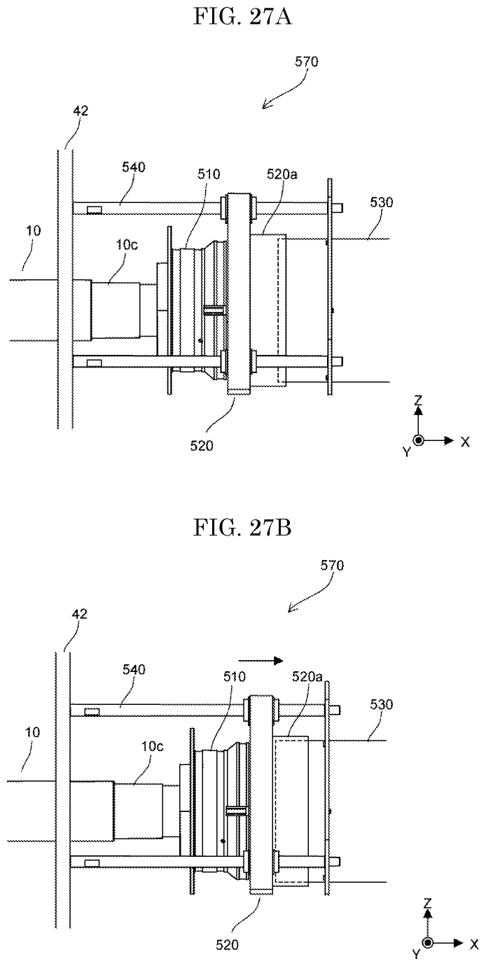

FIGS. 27A and 27B are side views of exhaust unit 570 showing states before and after moving fixing member 520 in a longitudinal direction.

When ink roller 10 is driven in X-axis positive direction from a state in FIG. 27A, fixing member 520 moves in the X-axis positive direction in association with hood member 510 connected to the end portion of support member 10c as shown in FIG. 27B. In this manner, by the movement of fixing member 520, duct 530 is deeply inserted into an interior of fixing member 520. In this case, duct 530 moves relatively with respect to fixing member 120 with an outer peripheral surface in sliding contact with an inner peripheral surface of flange 520a of fixing member 520. Therefore, high confidentiality between duct 530 and fixing member 520 is maintained at a high level. Therefore, even when ink roller 10 is driven in the X-axis positive direction, the flow channel of exhaust unit 570 is maintained as a substantially sealed space.

### <Effects of Exemplary Embodiment>

The present exemplary embodiment exerts the following effects.

Confidentiality of the flow channel of cooling air near slip ring 550 can be secured by hood member 510, fixing member 520, and duct 530. Accordingly, the cooling air can be circulated efficiently in the interior of ink roller 10. Accordingly, heat can be removed smoothly from heat dissipating surfaces of thermoelectric converters 12, so that performance of thermoelectric converters 12 can be maintained at a high level. Therefore, the temperature of ink roller 10 can be controlled efficiently and stably. Therefore, high quality printing on the material to be printed is achieved.

As shown in FIG. 27A and FIG. 27B, fixing member 520 is supported with respect to frame 42 that supports ink roller 10 so as to be movable in the longitudinal direction of ink roller 10 (X-axis direction). Hence, fixing member 520 and duct 530 are fitted to each other so that a fitting range between fixing member 520 and duct 530 varies in association with the movement of fixing member 520 in the longitudinal direction (X-axis direction). Therefore, even when fixing member 520 moves in association with the movement of ink roller 10, confidentiality between fixing member 520 and duct 530 can be maintained at a high level, so that confidentiality of the flow channel of cooling air is secured.

As shown in FIG. 17, fixing member 520 is supported so as to be slidable in the longitudinal direction (X-axis direction) of ink roller 10 by three shafts 540 provided on frame 42. Accordingly, fixing member 520 and hood member 510 and slip ring 550 integrated with fixing member 520 can be moved stably in the longitudinal direction (X-axis direction) in association with the movement of ink roller 10.

As illustrated in FIG. 17, duct 530 is fixed to three shafts 540. Accordingly, a positional relationship between fixing member 520 and duct 530 is fixed in a direction parallel to Y-Z plane. Therefore, in association with the movement of ink roller 10 in the longitudinal direction (X-axis direction), fixing member 520 can be moved relatively with respect to duct 530 stably. Therefore, the fitting state between duct 530 and fixing member 520 is maintained, and simultaneously, fixing member 520 can be moved stably in the longitudinal direction (X-axis direction).

As shown in FIG. 26, hood member 510 and fixing member 520 are configured to increase in cross-sectional area parallel to the Y-Z plane from an end portion of support member 10c toward duct 530. Therefore, cooling air flowed in the interior of ink roller 10 can be guided smoothly into duct 530. Therefore, cooling air can be circulated further smoothly, and heat from heat dissipating surfaces of thermoelectric converters 12 can be removed further efficiently.

As described with reference to FIG. 25A, cables on thermoelectric converters 12 side and cables E2 on slip ring 550 side are connected on the outer periphery of hood member 510 (hood body 512). Accordingly, hindering of the flow of cooling air in the flow channel in the exhaust unit 570 by these cables can be suppressed. Therefore, cooling air can be circulated smoothly, and thus cooling efficiency of thermoelectric converters 12 can be enhanced.

In the second exemplary embodiment described above, the configuration shown in FIG. 17 is provided on the exhaust side of ink roller 10. However, the configuration shown in FIG. 17 may be provided on an air intake side of ink roller 10 or may be provided both on the air intake side and the exhaust side of ink roller 10. In a case where the configuration shown in FIG. 17 is provided both on the air intake side and the exhaust side of ink roller 10, cables led out from thermoelectric converters 12 may be connected separately to slip rings 550 disposed on the air intake side and the exhaust side.

Alternatively, the shape and the configuration of hood member 510 and the shape and the configuration of fixing member 520 may also be modified as needed. In the configuration in the second exemplary embodiment described above, duct 530 is inserted into flange 520a of fixing member 520. However, a configuration in which flange 520a of fixing member 520 is inserted into duct 530 is also applicable. In addition, end portions of shafts 540 on the X-axis positive side may be extended to cover 52 and fixed to cover 52. In this case, duct 530 is fixed to shafts 540 at intermediate positions of shafts 540.

### Modified Example

In the first and second exemplary embodiments described above, the configurations shown in FIG. 4A, FIG. 4B, and FIG. 6, and FIG. 17 are applied to ink roller 10. However, these configuration may be applied to other rollers such as plate cylinder 21 or blanket 22. It should be noted that the configurations shown in FIG. 4A, FIG. 4B, and FIG. 6, FIG. 17 may also be used as needed for rollers mounted on apparatus other than the printer.

In the exemplary embodiments described above, thermoelectric converters 12 are mounted on the inner peripheral surface of ink roller 10 with the configuration shown in FIG. 4A and FIG. 4B. However, the configuration for mounting thermoelectric converters 12 is not limited thereto. For example, in a case where thermoelectric converters 12 have flexibility, thermoelectric converters 12 may be configured to be brought into press contact with the inner peripheral surface of the ink roller 10 while being deformed. Also, the number of thermoelectric converters 12 disposed in the circumferential direction is not necessarily limited to six, and thermoelectric converters 12 may be provided one each in each of regions of half a circumference.

In addition to printing paper, the cooling object may be changed variously. The number of ink rollers 10 to be disposed in each of the printing units 3 is not limited to four. Printer 1 may have a configuration to perform printing on both sides of printing paper P1 instead of the configuration to perform printing on one side. In this case, the number of installation of the printing units 3 is changed as needed.

The exemplary embodiments of the present disclosure can be modified in various manners as appropriate within the scope of the technical idea recited in the claims.

### REFERENCE MARKS IN THE DRAWINGS

1: printer
2: paper feed unit (paper feed device)
3: printing unit
3a: ink storage
10: ink roller (roller)
12: thermoelectric converter (electronic device)
21: plate cylinder
51: cover
52: cover (duct fixing member)
53: duct
61: duct
100, 500: roller device
110, 530: duct
120, 540: shaft
140: nut (movement restriction member)
150, 520: fixing member
160, 510: hood member
210, 550: slip ring
211, 552: rotary shaft (rotating shaft)
220, 520: fixing plate (fixing member)
222, 223, 322, 331, 513b, 513c, 520e: ventilation hole
240: cylindrical member (fixing member)
250: cylindrical member (fixing member)
310: cylindrical member (hood member)
320, 513: coupling plate (hood member)
330, 511: flange (hood member)
340: cylindrical member (hood member)
E1, E2, E3: cable

1. A roller device comprising:
a roller;
an electronic device disposed in an interior of the roller;
a slip ring configured to supply electric power to the electronic device;
a hood member covering a first region between a rotating shaft of the slip ring and an end portion of the roller; and
a duct that covers the slip ring and extends in a direction away from the roller.

2. The roller device according to claim 1, wherein:
the slip ring is provided in the roller device to be movable in a longitudinal direction of the duct, and
an insertion amount of the slip ring in the duct varies as the slip ring moves in the longitudinal direction of the duct.

3. The roller device according to claim 1, further comprising a fixing member on which the slip ring is fixed,
wherein the fixing member is provided in the roller device to connect the duct to the first region covered with the hood member, the fixing member including a ventilation hole that communicates between the first region and the duct.

4. The roller device according to claim 3, wherein:
the fixing member is provided in the roller device to be movable in a longitudinal direction of the roller, and
the fixing member and the duct are fitted to each other so that a fitting range between the fixing member and the duct varies as the fixing member moves in the longitudinal direction of the roller.

5. The roller device according to claim 4, further comprising a plurality of shafts disposed on a duct fixing member that fixes the duct,
wherein the fixing member is supported by the plurality of shafts so that the plurality of shafts allow the fixing member to slide in the longitudinal direction of the duct.

6. The roller device according to claim 5, wherein at least one of the plurality of shafts includes a movement restriction member disposed at one of end portions of the at least one of the plurality of shafts, the movement restriction member being configured to restrict a movement of the fixing member.

7. The roller device according to claim 3, wherein:
the hood member is provided in the roller device to cover the fixing member at a side close to the roller, and
the fixing member is provided in the roller device to cover the duct at a side close to the roller.

8. The roller device according to claim 1, further comprising:
a first cable that is led out from the electronic device; and
a second cable that is led out from the slip ring,
wherein the first cable and the second cable are connected with each other inside the hood member.

9. The roller device according to claim 1, wherein the electronic device is a thermoelectric converter configured to remove heat from the roller.

10. A printer comprising:
the roller device according to claim 1; and
a paper feed device configured to feed a sheet-shaped material to be printed to the roller device,
wherein ink is transferred to the sheet-shaped material to be printed by the roller device.

11. The printer according to claim 10, further comprising:
an ink storage; and
a plate cylinder,
wherein the roller is an ink roller configured to guide the ink from the ink storage to the plate cylinder.
